(19) United States
(12) Patent Application Publication
(10) Pub. No.: US 2024/0221348 A1
(43) Pub. Date: Jul. 4, 2024

(54) IMAGE PROCESSING APPARATUS, IMAGE PROCESSING METHOD, AND PROGRAM

(71) Applicant: FUJIFILM Corporation, Tokyo (JP)

(72) Inventors: Shinya FUJIWARA, Saitama-shi (JP); Yukinori NISHIYAMA, Saitama-shi (JP); Masaru KOBAYASHI, Saitama-shi (JP)

(73) Assignee: FUJIFILM Corporation, Tokyo (JP)

(21) Appl. No.: 18/610,221

(22) Filed: Mar. 19, 2024

Related U.S. Application Data
(63) Continuation of application No. PCT/JP2022/019583, filed on May 6, 2022.

(30) Foreign Application Priority Data
Sep. 27, 2021 (JP) 2021-157104

(51) Int. Cl. G06V 10/60; G06T 5/40; G06T 7/11; G06V 10/74; G06V 10/764

(52) U.S. Cl. CPC G06V 10/60; G06T 5/40; G06T 7/11; G06V 10/761; G06V 10/764

(57) ABSTRACT

There is provided an image processing apparatus including: a processor, in which the processor acquires distance data related to a distance between an image sensor and a subject, outputs first image data indicating a first image obtained by imaging with the image sensor, outputs first brightness data created based on a first signal of the first image data for at least a first region among a plurality of regions into which the first image is classified according to the distance data, and performs, in a case where a first instruction related to the first brightness data is received by a reception device, first processing of reflecting a content of the first instruction in the first image data and/or the first brightness data.

This application is a continuation application of International Application No. PCT/JP2022/019583, filed May 6, 2022, the disclosure of which is incorporated herein by reference in its entirety. Further, this application claims priority under 35 USC 119 from Japanese Patent Application No. 2021-157104 filed Sep. 27, 2021, the disclosure of which is incorporated by reference herein.

### BACKGROUND OF THE INVENTION

### 1. Field of the Invention

The technology of the present disclosure relates to an image processing apparatus, an image processing method, and a program.

### 2. Description of the Related Art

JP2013-135308A discloses an imaging apparatus including an imaging element that generates an image signal, a distance calculation unit that calculates a distance from the image signal to a subject, a reliability degree calculation unit that calculates a reliability degree of a calculation result of the distance calculation unit, a histogram generation unit that generates a plurality of histograms according to the distance to the subject based on a calculation result of the reliability degree and the calculation result of the distance to the subject, and a display unit that displays the plurality of histograms.

JP2013-201701A discloses an imaging device including an imaging unit that has an imaging element which images a subject, a display unit that displays an image based on image data acquired by the imaging unit, a touch panel that is disposed on a display surface of the display unit, a light source detection unit that detects a light source within the image being displayed on the display unit, an operation input determination unit that detects and determines coordinate data corresponding to an input operation on the touch panel, a control unit that sets a designated region within the image based on the coordinate data detected by the operation input determination unit, a brightness distribution determination unit that determines a brightness distribution of a region corresponding to the coordinate data determined by the operation input determination unit, a brightness distribution enhancement unit that performs brightness enhancement processing on a predetermined region within the image, and a recording unit that records the image data, in which the brightness distribution enhancement unit performs brightness enhancement processing on the designated region set by the control unit.

JP2018-093474A discloses an image processing apparatus including an image acquisition unit that acquires an image of a subject, a calculation unit that calculates a ratio of pixels included within a brightness range set in advance to the entire image, an image processing unit that enhances a contrast of the image in a case where the ratio is equal to or greater than a first threshold value, and a control unit that changes the brightness range for calculating the ratio according to at least one of illuminance of the subject or an exposure target value in a case of acquiring the image.

### SUMMARY OF THE INVENTION

One embodiment according to the technology of the present disclosure provides an image processing apparatus, an image processing method, and a program capable of changing an aspect of a first image and/or first brightness information according to an instruction received by a reception device, for example.

According to the present disclosure, there is provided an image processing apparatus comprising: a processor, in which the processor is configured to: acquire distance information data related to distance information between an image sensor and a subject; output first image data indicating a first image obtained by imaging with the image sensor; output first brightness information data indicating first brightness information created based on a first signal of the first image data for at least a first region among a plurality of regions into which the first image is classified according to the distance information; and perform, in a case where a first instruction related to the first brightness information is received by a reception device, first processing of reflecting a content of the first instruction in the first image and/or the first brightness information.

The first brightness information may be a first histogram.

The first histogram may indicate a relationship between a signal value and the number of pixels.

The processor may be configured to output second brightness information data indicating second brightness information created based on a second signal of the first image data for a second region among the plurality of regions, and the first processing may include second processing of prohibiting the content of the first instruction from being reflected in the second region and/or the second brightness information.

The processor may be configured to output third brightness information data indicating third brightness information created based on a third signal of the first image data for a third region among the plurality of regions, and the first processing may include third processing of reflecting the content of the first instruction in the third region and/or the third brightness information.

The first processing may be processing of changing the first signal according to the content of the first instruction, the third processing may be processing of changing the third signal according to the content of the first instruction, and a change amount of a first signal value included in the first signal may be different from a change amount of a second signal value included in the third signal.

In a case where a range of distances between a plurality of first pixels corresponding to the first region and the subject is set as a first distance range, and a range of distances between a plurality of second pixels corresponding to the third region and the subject is set as a second distance range, the change amount of the first signal value may be constant in the first distance range, and the change amount of the second signal value may be constant in the second distance range.

The first processing may be processing of changing the first signal according to the content of the first instruction, the third processing may be processing of changing the third signal according to the content of the first instruction, and a change amount of a second signal value included in the third signal may vary depending on distances between a plurality of second pixels corresponding to the third region and the subject.

The first processing may be processing of changing the first signal according to the content of the first instruction.

The first instruction may be an instruction to change a form of the first brightness information.

The first brightness information may be a second histogram having a plurality of bins, and the first instruction may be an instruction to move a bin corresponding to a third signal value selected based on the first instruction among the plurality of bins.

The processor may be configured to output second image data indicating a second image in which the plurality of regions are divided in different aspects according to the distance information.

The processor may be configured to: output third image data indicating a distance map image representing a distribution of the distance information with respect to an angle of view of a first imaging apparatus equipped with the image sensor; and output fourth image data indicating a reference distance image representing a reference distance for classifying the plurality of regions.

The reference distance image may be an image showing a scale bar and a slider, the scale bar may indicate a plurality of distance ranges corresponding to the plurality of regions, the slider may be provided on the scale bar, and a position of the slider may indicate the reference distance.

The scale bar may be one scale bar collectively indicating the plurality of distance ranges.

The scale bar may be a plurality of scale bars separately indicating the plurality of distance ranges.

The processor may be configured to, in a case where the reception device receives a second instruction to output the third image data and/or the fourth image data, output fifth image data indicating a third image in which the plurality of regions are divided in different aspects according to the distance information.

The processor may be configured to, in a case where the reception device receives a third instruction related to the reference distance, perform fourth processing of reflecting a content of the third instruction in the reference distance image, and change the reference distance according to the content of the third instruction.

The first image data may be moving image data.

The image processing apparatus may be an imaging apparatus.

The processor may be configured to output the first image data and/or the first brightness information data to a display destination.

The first processing may be processing of changing a display aspect of the first image and/or the first brightness information displayed on the display destination.

The image sensor may have a plurality of phase difference pixels, and the processor may be configured to acquire the distance information data based on phase difference pixel data output from the phase difference pixels.

The phase difference pixel may be a pixel for selectively outputting non-phase difference pixel data and the phase difference pixel data, the non-phase difference pixel data may be pixel data obtained by performing photoelectric conversion on an entire region of the phase difference pixel, and the phase difference pixel data may be pixel data obtained by performing photoelectric conversion on a partial region of the phase difference pixel.

According to the present disclosure, there is provided an image processing method comprising: acquiring distance information data related to distance information between an image sensor and a subject; outputting first image data indicating a first image obtained by imaging with the image sensor; outputting first brightness information data indicating first brightness information created based on a first signal of the first image data for at least a first region among a plurality of regions into which the first image is classified according to the distance information; and performing, in a case where a first instruction related to the first brightness information is received by a reception device, first processing of reflecting a content of the first instruction in the first image and/or the first brightness information.

According to the present disclosure, there is provided a program for causing a computer to execute a process comprising: acquiring distance information data related to distance information between an image sensor and a subject; outputting first image data indicating a first image obtained by imaging with the image sensor; outputting first brightness information data indicating first brightness information created based on a first signal of the first image data for at least a first region among a plurality of regions into which the first image is classified according to the distance information; and performing, in a case where a first instruction related to the first brightness information is received by a reception device, first processing of reflecting a content of the first instruction in the first image and/or the first brightness information.

### BRIEF DESCRIPTION OF THE DRAWINGS

FIG. 1 is a schematic configuration diagram showing an example of a configuration of an imaging apparatus according to an embodiment.

FIG. 2 is a schematic configuration diagram showing an example of hardware configurations of an optical system and an electrical system of the imaging apparatus according to the embodiment.

FIG. 3 is a schematic configuration diagram showing an example of a configuration of a photoelectric conversion element according to the embodiment.

FIG. 4 is a block diagram showing an example of a functional configuration of a CPU according to the embodiment.

FIG. 5 is a block diagram showing an example of a functional configuration of an operation mode setting processing unit according to the embodiment.

FIG. 6 is a block diagram showing an example of a functional configuration of an imaging processing unit according to the embodiment.

FIG. 7 is a block diagram showing an example of a functional configuration of an image adjustment processing unit according to the embodiment.

FIG. 8 is an operation explanatory diagram showing an example of a first operation of the image adjustment processing unit according to the embodiment.

FIG. 9 is an operation explanatory diagram showing an example of a second operation of the image adjustment processing unit according to the embodiment.

FIG. 10 is an operation explanatory diagram showing an example of a third operation of the image adjustment processing unit according to the embodiment.

FIG. 11 is an operation explanatory diagram showing an example of a fourth operation of the image adjustment processing unit according to the embodiment.

FIG. 12 is an operation explanatory diagram showing an example of a fifth operation of the image adjustment processing unit according to the embodiment.

FIG. 13 is an operation explanatory diagram showing an example of a sixth operation of the image adjustment processing unit according to the embodiment.

FIG. 14 is a graph showing a first example of a relationship between a signal value before processing and a signal value after processing.

FIG. 15 is an operation explanatory diagram showing an example of a seventh operation of the image adjustment processing unit according to the embodiment.

FIG. 16 is an operation explanatory diagram showing an example of an eighth operation of the image adjustment processing unit according to the embodiment.

FIG. 17 is an operation explanatory diagram showing an example of a ninth operation of the image adjustment processing unit according to the embodiment.

FIG. 18 is an operation explanatory diagram showing an example of a tenth operation of the image adjustment processing unit according to the embodiment.

FIG. 19 is a graph showing a second example of the relationship between the signal value before processing and the signal value after processing.

FIG. 20 is an operation explanatory diagram showing an example of an eleventh operation of the image adjustment processing unit according to the embodiment.

FIG. 21 is an operation explanatory diagram showing an example of a twelfth operation of the image adjustment processing unit according to the embodiment.

FIG. 22 is a graph showing a third example of the relationship between the signal value before processing and the signal value after processing.

FIG. 23 is an operation explanatory diagram showing an example of a thirteenth operation of the image adjustment processing unit according to the embodiment.

FIG. 24 is a block diagram showing an example of a functional configuration of a reference distance change processing unit according to the embodiment.

FIG. 25 is an operation explanatory diagram showing an example of a first operation of the reference distance change processing unit according to the embodiment.

FIG. 26 is an operation explanatory diagram showing an example of a second operation of the reference distance change processing unit according to the embodiment.

FIG. 27 is an operation explanatory diagram showing an example of a third operation of the reference distance change processing unit according to the embodiment.

FIG. 28 is an operation explanatory diagram showing an example of a fourth operation of the reference distance change processing unit according to the embodiment.

FIG. 29 is an operation explanatory diagram showing an example of a fifth operation of the reference distance change processing unit according to the embodiment.

FIG. 30 is an operation explanatory diagram showing an example of a sixth operation of the reference distance change processing unit according to the embodiment.

FIG. 31 is an operation explanatory diagram showing an example of a seventh operation of the reference distance change processing unit according to the embodiment.

FIG. 32 is an operation explanatory diagram showing an example of an eighth operation of the reference distance change processing unit according to the embodiment.

FIG. 33 is an operation explanatory diagram showing an example of a ninth operation of the reference distance change processing unit according to the embodiment.

FIG. 34 is a flowchart showing an example of a flow of operation mode setting processing according to the embodiment.

FIG. 35 is a flowchart showing an example of a flow of imaging processing according to the embodiment.

FIG. 36 is a flowchart showing an example of a flow of image adjustment processing according to the embodiment.

FIG. 37 is a flowchart showing an example of a flow of reference distance change processing according to the embodiment.

FIG. 38 is a diagram showing a first modification example of processing intensity data according to the embodiment.

FIG. 39 is a diagram showing an example of a state where forms of a plurality of histograms according to the embodiment are changed according to processing intensity.

FIG. 40 is a diagram showing a second modification example of the processing intensity data according to the embodiment.

FIG. 41 is a diagram showing a third modification example of the processing intensity data according to the embodiment.

FIG. 42 is a diagram showing a modification example of a reference distance image according to the embodiment.

FIG. 43 is a diagram showing a modification example of brightness information according to the embodiment.

### DESCRIPTION OF THE PREFERRED EMBODIMENTS

Hereinafter, examples of an image processing apparatus, an image processing method, and a program according to the technology of the present disclosure will be described with reference to the accompanying drawings.

First, terms that are used in the following description will be described.

CMOS is an abbreviation for “complementary metal oxide semiconductor”. CCD is an abbreviation for “charge coupled device”. EL is an abbreviation for “electro-luminescence”. fps is an abbreviation for “frame per second”. CPU is an abbreviation for “central processing unit”. NVM is an abbreviation for “non-volatile memory”. RAM is an abbreviation for “random access memory”. EEPROM is an abbreviation for “electrically erasable and programmable read only memory”. HDD is an abbreviation for “hard disk drive”. SSD is an abbreviation for “solid state drive”. ASIC is an abbreviation for “application specific integrated circuit”. FPGA is an abbreviation for “field-programmable gate array”. PLD is an abbreviation for “programmable logic device”. MF is an abbreviation for “manual focus”. AF is an abbreviation for “auto focus”. UI is an abbreviation for “user interface”. I/F is an abbreviation for “interface”. A/D is an abbreviation for “analog/digital”. USB is an abbreviation for “universal serial bus”. LiDAR is an abbreviation for “light detection and ranging”. TOF is an abbreviation for “time of flight”. GPU is an abbreviation for “graphics processing unit”. TPU is an abbreviation for “tensor processing unit”. SoC is an abbreviation for “system-on-a-chip”. IC is an abbreviation for “integrated circuit”.

In the present specification, the term “parallel” refers not only to being completely parallel but also to being parallel in the sense of including an error that is generally allowed in the technical field to which the technology of the present disclosure belongs and that does not contradict the gist of the technology of the present disclosure. In addition, in the present specification, the term “orthogonal” refers not only to being completely orthogonal but also to being orthogonal in the sense of including an error that is generally allowed in the technical field to which the technology of the present disclosure belongs and that does not contradict the gist of the technology of the present disclosure. Further, in the description of the present specification, the term “match” refers not only to perfect matching but also to matching in the sense of including an error that is generally allowed in the technical field to which the technology of the present disclosure belongs and that does not contradict the gist of the technology of the present disclosure. Further, in the following description, a numerical range represented by using “to” means a range including numerical values described before and after “to” as a lower limit value and an upper limit value.

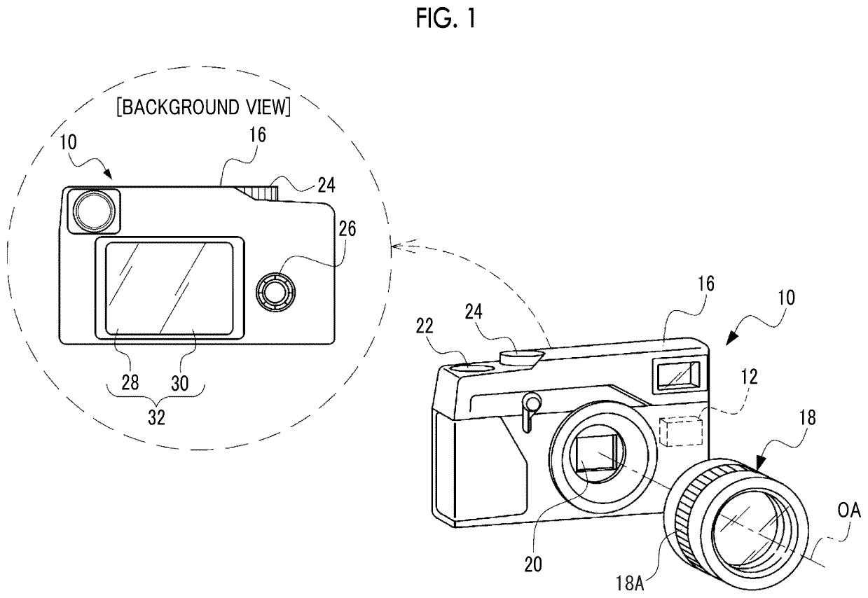

As shown in FIG. 1 as an example, an imaging apparatus 10 is an apparatus that images a subject (not shown), and comprises a controller 12, an imaging apparatus body 16, and an interchangeable lens 18. The imaging apparatus 10 is an example of an “image processing apparatus”, an “imaging apparatus”, and a “first imaging apparatus” according to the technology of the present disclosure, and the controller 12 is an example of a “computer” according to the technology of the present disclosure.

The controller 12 is built into the imaging apparatus body 16 and controls the entire imaging apparatus 10. The interchangeable lens 18 is interchangeably mounted on the imaging apparatus body 16.

In the example shown in FIG. 1, a lens-interchangeable digital camera is shown as an example of the imaging apparatus 10. However, this example is merely an example, and the imaging apparatus 10 may be a lens-fixed digital camera or may be a digital camera built into various electronic devices such as a smart device, a wearable terminal, a cell observation apparatus, an ophthalmologic observation apparatus, or a surgical microscope.

The imaging apparatus body 16 is provided with an image sensor 20. The image sensor 20 is an example of an “image sensor” according to the technology of the present disclosure. The image sensor 20 is, as an example, a CMOS image sensor. The image sensor 20 images an imaging area including at least one subject. In a case where the interchangeable lens 18 is mounted on the imaging apparatus body 16, subject light indicating the subject is transmitted through the interchangeable lens 18 and forms an image on the image sensor 20, and image data indicating an image of the subject is generated by the image sensor 20.

In the present embodiment, the CMOS image sensor is exemplified as the image sensor 20, but the technology of the present disclosure is not limited thereto, and the technology of the present disclosure is established, for example, even in a case where the image sensor 20 is another type of image sensor such as a CCD image sensor.

A release button 22 and a dial 24 are provided on an upper surface of the imaging apparatus body 16. The dial 24 is operated at the time of setting an operation mode of an imaging system, an operation mode of a reproduction system, and the like, and by operating the dial 24, an imaging mode, a reproduction mode, and a setting mode are selectively set as the operation mode in the imaging apparatus 10. The imaging mode is an operation mode for causing the imaging apparatus 10 to perform imaging. The reproduction mode is an operation mode for reproducing an image (for example, a still image and/or a moving image) obtained by performing imaging for recording in the imaging mode. The setting mode is an operation mode for setting the imaging apparatus 10 in a case where various setting values used in control related to imaging are set, and the like. In addition, in the imaging apparatus 10, an image adjustment mode and a reference distance change mode are selectively set as the operation mode. The image adjustment mode and the reference distance change mode will be described below in detail.

The release button 22 functions as an imaging preparation instruction unit and an imaging instruction unit, and a two-step pressing operation between an imaging preparation instruction state and an imaging instruction state can be detected. For example, the imaging preparation instruction state refers to a state where the release button is pressed from a standby position to an intermediate position (half-pressed position), and the imaging instruction state refers to a state where the release button is pressed to a final pressed position (fully pressed position) beyond the intermediate position. Hereinafter, a “state of being pressed from the standby position to the half-pressed position” is referred to as a “half-pressed state”, and a “state of being pressed from the standby position to the fully pressed position” is referred to as a “fully pressed state”. Depending on the configuration of the imaging apparatus 10, the imaging preparation instruction state may be a state where a user's finger is in contact with the release button 22, and the imaging instruction state may be a state where the operating user's finger has moved from a state where the finger is in contact with the release button 22 to a state where the finger is separated from the release button 22.

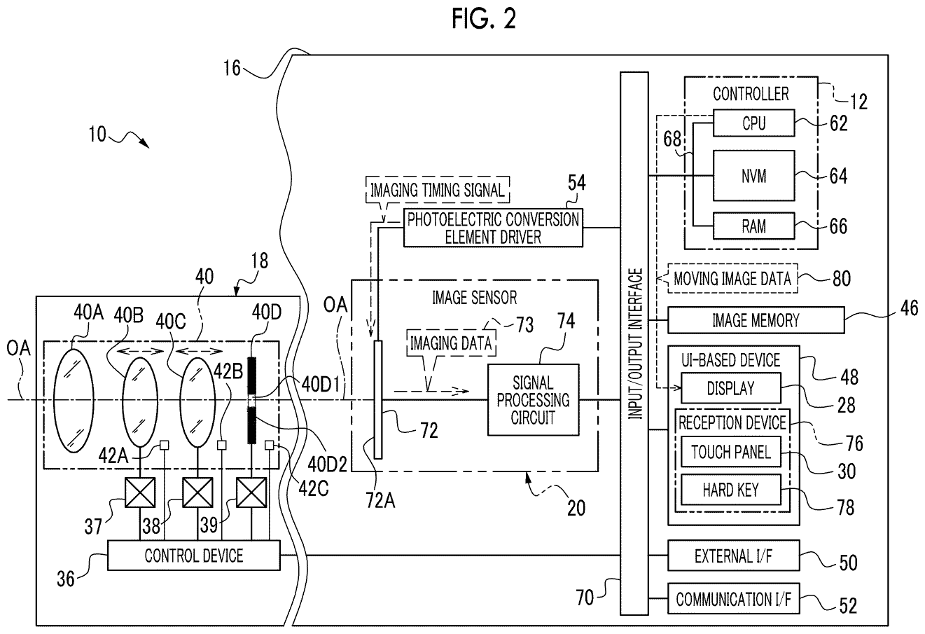

An instruction key 26 and a touch panel display 32 are provided on a rear surface of the imaging apparatus body 16. The touch panel display 32 comprises a display 28 and a touch panel 30 (see also FIG. 2). An example of the display 28 includes an EL display (for example, an organic EL display or an inorganic EL display). The display 28 may not be an EL display but be another type of display such as a liquid crystal display.

The display 28 displays an image and/or a character and the like. For example, in a case where the operation mode of the imaging apparatus 10 is the imaging mode, the display 28 is used to display a live view image obtained by performing imaging for a live view image, that is, continuous imaging. Here, the “live view image” refers to a moving image for display based on the image data obtained by imaging with the image sensor 20. The display 28 is one example of a “display destination” according to the technology of the present disclosure.

The instruction key 26 receives various instructions. Here, “various instructions” refer to, for example, an instruction to display a menu screen, an instruction to select one or a plurality of menus, an instruction to finalize a selected content, an instruction to erase the selected content, and various instructions such as zoom-in, zoom-out, and frame advance. Further, these instructions may also be given through the touch panel 30.

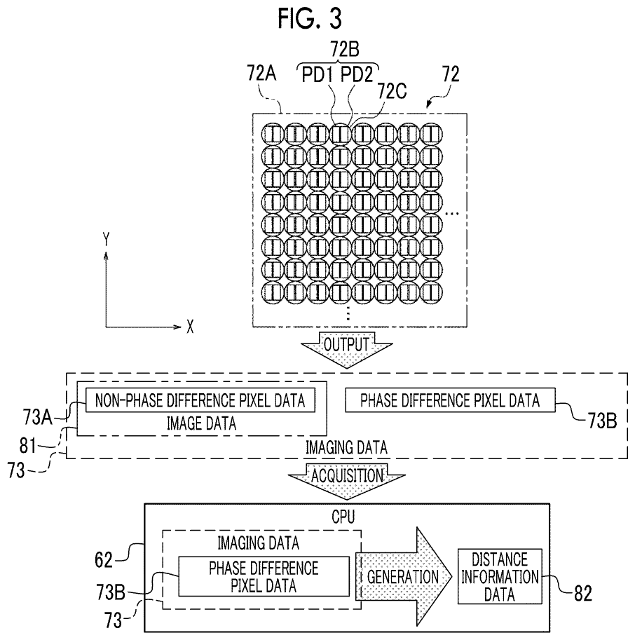

As shown in FIG. 2 as an example, the image sensor 20 comprises a photoelectric conversion element 72. The photoelectric conversion element 72 has a light-receiving surface 72A. The photoelectric conversion element 72 is disposed in the imaging apparatus body 16 such that a center of the light-receiving surface 72A and an optical axis OA of the interchangeable lens 18 match (see also FIG. 1). The photoelectric conversion element 72 has a plurality of photosensitive pixels 72B (see FIG. 3) arranged in a matrix shape, and the light-receiving surface 72A is formed by the plurality of photosensitive pixels 72B. Each photosensitive pixel 72B has a microlens 72C (see FIG. 3). Each photosensitive pixel 72B is a physical pixel having a photodiode (not shown), photoelectrically converts received light, and outputs an electrical signal corresponding to an amount of received light.

Moreover, in the plurality of photosensitive pixels 72B, color filters (not shown) of red (R), green (G), or blue (B) are arranged in a matrix shape in a predetermined pattern array (for example, a Bayer array, an RGB stripe array, an R/G checkered array, an X-Trans (a registered trademark) array, a honeycomb array, or the like).

The interchangeable lens 18 comprises an imaging lens 40. The imaging lens 40 has an objective lens 40A, a focus lens 40B, a zoom lens 40C, and a stop 40D. The objective lens 40A, the focus lens 40B, the zoom lens 40C, and the stop 40D are disposed in the order of the objective lens 40A, the focus lens 40B, the zoom lens 40C, and the stop 40D along the optical axis OA from a subject side (an object side) to an imaging apparatus body 16 side (image side).

Further, the interchangeable lens 18 comprises a control device 36, a first actuator 37, a second actuator 38, a third actuator 39, a first position sensor 42A, a second position sensor 42B, and a stop amount sensor 42C. The control device 36 controls the entire interchangeable lens 18 in accordance with an instruction from the imaging apparatus body 16. The control device 36 is, for example, a device having a computer including a CPU, an NVM, a RAM, and the like. The NVM of the control device 36 is, for example, an EEPROM. However, this is merely an example, and an HDD and/or an SSD or the like may be applied as the NVM of the control device 36 instead of the EEPROM or together with the EEPROM. In addition, the RAM of the control device 36 temporarily stores various kinds of information and is used as a work memory. In the control device 36, the CPU reads out a necessary program from the NVM and executes the read-out various programs on the RAM to control the entire interchangeable lens 18.

Here, although a device having a computer has been described as an example of the control device 36, this is merely an example, and a device including an ASIC, an FPGA, and/or a PLD may be applied. Further, as the control device 36, for example, a device implemented by a combination of a hardware configuration and a software configuration may be used.

The first actuator 37 comprises a focus slide mechanism (not shown) and a focus motor (not shown). The focus lens 40B is attached to the focus slide mechanism so as to be slidable along the optical axis OA. In addition, the focus motor is connected to the focus slide mechanism, and the focus slide mechanism operates by receiving power of the focus motor to move the focus lens 40B along the optical axis OA.

The second actuator 38 comprises a zoom slide mechanism (not shown) and a zoom motor (not shown). The zoom lens 40C is attached to the zoom slide mechanism so as to be slidable along the optical axis OA. In addition, the zoom motor is connected to the zoom slide mechanism, and the zoom slide mechanism operates by receiving power of the zoom motor to move the zoom lens 40C along the optical axis OA.

Note that an example of a form in which the focus slide mechanism and the zoom slide mechanism are separately provided has been described here, but this is merely an example, and an integrated slide mechanism capable of implementing both focus and zoom may be used. Further, in this case, the power generated by one motor need only be transmitted to the slide mechanism without using the focus motor and the zoom motor.

The third actuator 39 comprises a power transmission mechanism (not shown) and a stop motor (not shown). The stop 40D has an opening 40D1 and is a stop in which a size of the opening 40D1 is variable. The opening 40D1 is formed by, for example, a plurality of blades 40D2. The plurality of blades 40D2 are joined to the power transmission mechanism. Further, the stop motor is connected to the power transmission mechanism, and the power transmission mechanism transmits power of the stop motor to the plurality of blades 40D2. The plurality of blades 40D2 operate by receiving the power transmitted from the power transmission mechanism to change the size of the opening 40D1. By changing the size of the opening 40D1, a stop amount by the stop 40D changes, whereby the exposure is adjusted.

The focus motor, the zoom motor, and the stop motor are connected to the control device 36, and each drive of the focus motor, the zoom motor, and the stop motor is controlled by the control device 36. In the present embodiment, a stepping motor is employed as an example of the focus motor, the zoom motor, and the stop motor. Therefore, the focus motor, the zoom motor, and the stop motor operate in synchronization with a pulse signal in response to a command from the control device 36. Although an example in which the focus motor, the zoom motor, and the stop motor are provided in the interchangeable lens 18 has been described here, this is merely an example, and at least one of the focus motor, the zoom motor, or the stop motor may be provided in the imaging apparatus body 16. The constituent and/or the operation method of the interchangeable lens 18 can be changed as necessary.

The first position sensor 42A detects a position of the focus lens 40B on the optical axis OA. An example of the first position sensor 42A includes a potentiometer. A detection result of the first position sensor 42A is acquired by the control device 36.

The second position sensor 42B detects a position of the zoom lens 40C on the optical axis OA. An example of the second position sensor 42B includes a potentiometer. A detection result of the second position sensor 42B is acquired by the control device 36.

The stop amount sensor 42C detects the size of the opening 40D1 (that is, the stop amount). An example of the stop amount sensor 42C includes a potentiometer. A detection result of the stop amount sensor 42C is acquired by the control device 36.

In the imaging apparatus 10, in a case where the operation mode is the imaging mode, an MF mode and an AF mode are selectively set in accordance with an instruction given to the imaging apparatus body 16. The MF mode is an operation mode for performing manual focusing. In the MF mode, for example, a focus ring 18A (see FIG. 1) or the like is operated by the user so that the focus lens 40B is moved along the optical axis OA by a movement amount corresponding to an operation amount of the focus ring 18A or the like, whereby a position of the focus is adjusted. In the AF mode, AF is performed. AF refers to processing of adjusting the position of the focus in accordance with a signal obtained from the image sensor 20. For example, in the AF mode, a distance between the imaging apparatus 10 and the subject is calculated by the imaging apparatus body 16, the focus lens 40B is moved along the optical axis OA to a position where the subject is in focus, whereby the position of the focus is adjusted.

The imaging apparatus body 16 comprises the image sensor 20, the controller 12, an image memory 46, a UI-based device 48, an external I/F 50, a communication I/F 52, a photoelectric conversion element driver 54, and an input/output interface 70. In addition, the image sensor 20 comprises the photoelectric conversion element 72 and a signal processing circuit 74.

The controller 12, the image memory 46, the UI-based device 48, the external I/F 50, the communication I/F 52, the photoelectric conversion element driver 54, and the signal processing circuit 74 are connected to the input/output interface 70. Additionally, the control device 36 of the interchangeable lens 18 is also connected to the input/output interface 70.

The controller 12 controls the entire imaging apparatus 10. That is, in the example shown in FIG. 2, the image memory 46, the UI-based device 48, the external I/F 50, the communication I/F 52, the photoelectric conversion element driver 54, and the control device 36 are controlled by the controller 12. The controller 12 comprises a CPU 62, an NVM 64, and a RAM 66. The CPU 62 is an example of a “processor” according to the technology of the present disclosure, and the NVM 64 and/or the RAM 66 is an example of a “memory” according to the technology of the present disclosure.

The CPU 62, the NVM 64, and the RAM 66 are connected via a bus 68, and the bus 68 is connected to the input/output interface 70.

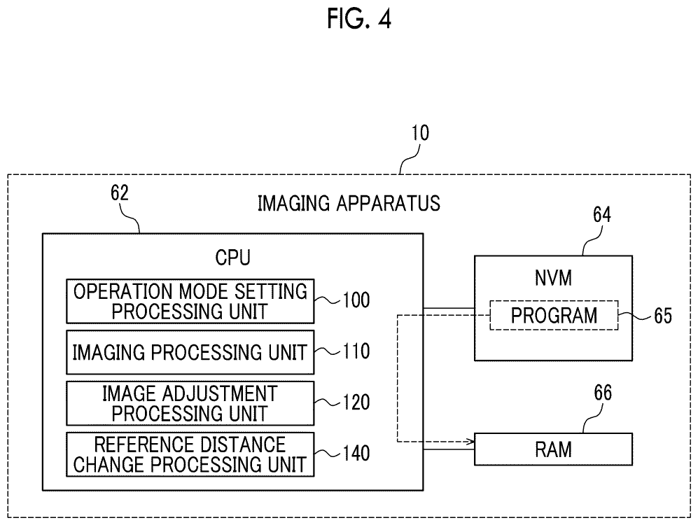

The NVM 64 is a non-transitory storage medium and stores various parameters and various programs. The various programs include a program 65 (see FIG. 4) which will be described below. The NVM 64 is, for example, an EEPROM. However, this is merely an example, and an HDD and/or an SSD or the like may be applied as the NVM 64 instead of the EEPROM or together with the EEPROM. Moreover, the RAM 66 temporarily stores various kinds of information and is used as a work memory. The CPU 62 reads out a necessary program from the NVM 64 and executes the read-out program on the RAM 66.

The CPU 62 acquires the detection result of the first position sensor 42A from the control device 36 and controls the control device 36 based on the detection result of the first position sensor 42A to adjust the position of the focus lens 40B on the optical axis OA. Further, the CPU 62 acquires the detection result of the second position sensor 42B from the control device 36 and controls the control device 36 based on the detection result of the second position sensor 42B to adjust the position of the zoom lens 40C on the optical axis OA. Furthermore, the CPU 62 acquires a detection result of the stop amount sensor 42C from the control device 36 and controls the control device 36 based on the detection result of the stop amount sensor 42C to adjust the size of the opening 40D1.

The photoelectric conversion element driver 54 is connected to the photoelectric conversion element 72. The photoelectric conversion element driver 54 supplies an imaging timing signal that defines a timing of imaging performed by the photoelectric conversion element 72 to the photoelectric conversion element 72 in accordance with an instruction from the CPU 62. The photoelectric conversion element 72 performs reset, exposure, and output of an electrical signal in accordance with the imaging timing signal supplied from the photoelectric conversion element driver 54. Examples of the imaging timing signal include a vertical synchronization signal and a horizontal synchronization signal.

In a case where the interchangeable lens 18 is mounted on the imaging apparatus body 16, the subject light incident on the imaging lens 40 forms an image on the light-receiving surface 72A through the imaging lens 40. The photoelectric conversion element 72 photoelectrically converts the subject light received by the light-receiving surface 72A under the control of the photoelectric conversion element driver 54 and outputs an electrical signal corresponding to the amount of the subject light to the signal processing circuit 74 as imaging data 73 indicating the subject light. Specifically, the signal processing circuit 74 reads out the imaging data 73 from the photoelectric conversion element 72 in units of one frame and for each horizontal line by using an exposure sequential readout method.

The signal processing circuit 74 digitizes the analog imaging data 73 read out from the photoelectric conversion element 72. The imaging data 73 digitized by the signal processing circuit 74 is so-called RAW image data. The RAW image data is image data indicating an image in which R pixels, G pixels, and B pixels are arranged in a mosaic shape.

The signal processing circuit 74 stores the imaging data 73 in the image memory 46 by outputting the digitized imaging data 73 to the image memory 46. The CPU 62 performs image processing (for example, white balance processing and/or color correction or the like) on the imaging data 73 in the image memory 46. The CPU 62 generates moving image data 80 based on the imaging data 73. An example of the moving image data 80 includes moving image data for display, that is, live view image data indicating a live view image. Although the live view image data is exemplified here, this is merely an example, and the moving image data 80 may be post-view image data indicating a post-view image.

The UI-based device 48 comprises the display 28. The CPU 62 causes the display 28 to display an image based on the moving image data 80 (here, as an example, a live view image). In addition, the CPU 62 causes the display 28 to display various kinds of information.

In addition, the UI-based device 48 comprises a reception device 76. The reception device 76 comprises the touch panel 30 and a hard key unit 78 and receives an instruction from the user. The hard key unit 78 is a plurality of hard keys including the instruction key 26 (see FIG. 1). The CPU 62 operates in accordance with various instructions received by the touch panel 30.

The external I/F 50 manages transmission and reception of various kinds of information to and from a device existing outside the imaging apparatus 10 (hereinafter, also referred to as an “external device”). An example of the external I/F 50 includes a USB interface. An external device (not shown) such as a smart device, a personal computer, a server, a USB memory, a memory card, and/or a printer is directly or indirectly connected to the USB interface.

The communication I/F 52 is connected to a network (not shown). The communication I/F 52 manages transmission and reception of information between the controller 12 and a communication device (not shown) such as a server on the network. For example, the communication I/F 52 transmits information corresponding to a request from the controller 12 to the communication device via the network. In addition, the communication I/F 52 receives information transmitted from the communication device and outputs the received information to the controller 12 via the input/output interface 70.

As shown in FIG. 3 as an example, the plurality of photosensitive pixels 72B are two dimensionally arranged on the light-receiving surface 72A of the photoelectric conversion element 72. The color filter (not shown) and the microlens 72C are disposed in each photosensitive pixel 72B. In FIG. 3, one direction parallel to the light-receiving surface 72A (for example, a row direction of the plurality of photosensitive pixels 72B arranged two dimensionally) is defined as an X direction, and a direction orthogonal to the X direction (for example, a column direction of the plurality of photosensitive pixels 72B arranged two dimensionally) is defined as a Y direction. The plurality of photosensitive pixels 72B are arranged along the X direction and the Y direction. Each photosensitive pixel 72B includes an independent pair of photodiodes PD1 and PD2. A first luminous flux (for example, a luminous flux passing through a first pupil partial region in the imaging lens 40 (see FIG. 2)) obtained by pupil-splitting a luminous flux indicating the subject (hereinafter, also referred to as a “subject luminous flux”), which is transmitted through the imaging lens 40, is incident on the photodiode PD1, and a second luminous flux (for example, a luminous flux passing through a second pupil partial region in the imaging lens 40 (see FIG. 2)) obtained by pupil-splitting the subject luminous flux is incident on the photodiode PD2. The photodiode PD1 performs photoelectric conversion on the first luminous flux. The photodiode PD2 performs photoelectric conversion on the second luminous flux.

As an example, the photoelectric conversion element 72 is an image plane phase difference type photoelectric conversion element in which a pair of photodiodes PD1 and PD2 are provided in one photosensitive pixel 72B. As an example, in the photoelectric conversion element 72, the photosensitive pixels 72B all have a function of outputting data related to imaging and phase differences. The photoelectric conversion element 72 is formed by combining the pair of photodiodes PD1 and PD2 into one photosensitive pixel, to output non-phase difference pixel data 73A. In addition, the photoelectric conversion element 72 detects a signal from each of the pair of photodiodes PD1 and PD2, thereby outputting phase difference pixel data 73B. That is, all the photosensitive pixels 72B provided in the photoelectric conversion element 72 are so-called phase difference pixels. The photosensitive pixel 72B is an example of a “phase difference pixel” according to the technology of the present disclosure.

The photosensitive pixel 72B is a pixel for selectively outputting the non-phase difference pixel data 73A and the phase difference pixel data 73B. The non-phase difference pixel data 73A is pixel data obtained by performing photoelectric conversion on the entire region of the photosensitive pixel 72B, and the phase difference pixel data 73B is pixel data obtained by performing photoelectric conversion on a partial region of the photosensitive pixel 72B. Here, the “entire region of the photosensitive pixel 72B” refers to a light-receiving region in which the photodiode PD1 and the photodiode PD2 are combined. Further, the “partial region of the photosensitive pixel 72B” refers to a light-receiving region of the photodiode PD1 or a light-receiving region of the photodiode PD2.

The non-phase difference pixel data 73A can also be generated based on the phase difference pixel data 73B. For example, the phase difference pixel data 73B is added for each pair of pixel signals corresponding to the pair of photodiodes PD1 and PD2, whereby the non-phase difference pixel data 73A is generated. Further, the phase difference pixel data 73B may include only data output from one of the pair of photodiodes PD1 and PD2. For example, in a case where the phase difference pixel data 73B includes only data output from the photodiode PD1, the phase difference pixel data 73B is subtracted from the non-phase difference pixel data 73A for each pixel, whereby data output from the photodiode PD2 is created.

The imaging data 73 includes image data 81 and the phase difference pixel data 73B. The image data 81 is generated based on the non-phase difference pixel data 73A. For example, the image data 81 is obtained by performing A/D conversion on the analog non-phase difference pixel data 73A. That is, the image data 81 is data obtained by digitizing the non-phase difference pixel data 73A output from the photoelectric conversion element 72. The CPU 62 acquires the digitized imaging data 73 from the signal processing circuit 74 and acquires distance information data 82 based on the acquired imaging data 73. For example, the CPU 62 acquires the phase difference pixel data 73B from the imaging data 73 and generates the distance information data 82 based on the acquired phase difference pixel data 73B. The distance information data 82 is an example of “distance information data” according to the technology of the present disclosure. The distance information data 82 is data related to distance information between the photoelectric conversion element 72 and the subject. The distance information is information regarding a distance between each photosensitive pixel 72B and the subject. Hereinafter, a distance between the photosensitive pixel 72B and a subject 202 is referred to as a subject distance. The distance information between the photoelectric conversion element 72 and the subject is synonymous with the distance information between the image sensor 20 and the subject. The distance information between the image sensor 20 and the subject is an example of “distance information” according to the technology of the present disclosure.

As shown in FIG. 4 as an example, the program 65 is stored in the NVM 64 of the imaging apparatus 10. The program 65 is an example of a “program” according to the technology of the present disclosure. The CPU 62 reads out the program 65 from the NVM 64, and executes the read-out program 65 on the RAM 66. The CPU 62 executes the program 65 to operate as an operation mode setting processing unit 100, an imaging processing unit 110, an image adjustment processing unit 120, and a reference distance change processing unit 140.

The imaging apparatus 10 has the imaging mode, the image adjustment mode, and the reference distance change mode as operation modes. The operation mode setting processing unit 100 selectively sets the imaging mode, the image adjustment mode, and the reference distance change mode as the operation mode of the imaging apparatus 10. In a case where the operation mode of the imaging apparatus 10 is set to the imaging mode by the operation mode setting processing unit 100, the CPU 62 operates as the imaging processing unit 110. In a case where the operation mode of the imaging apparatus 10 is set to the image adjustment mode by the operation mode setting processing unit 100, the CPU 62 operates as the image adjustment processing unit 120. In a case where the operation mode of the imaging apparatus 10 is set to the reference distance change mode by the operation mode setting processing unit 100, the CPU 62 operates as the reference distance change processing unit 140.

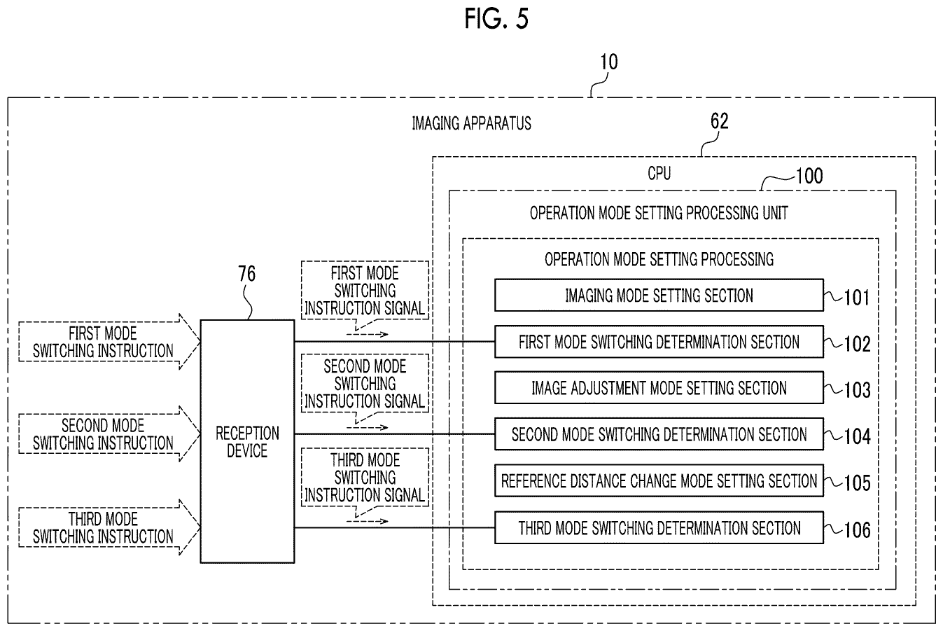

As shown in FIG. 5 as an example, the operation mode setting processing unit 100 performs operation mode setting processing for selectively setting the imaging mode, the image adjustment mode, and the reference distance change mode as the operation mode of the imaging apparatus 10. The operation mode setting processing unit 100 has an imaging mode setting section 101, a first mode switching determination section 102, an image adjustment mode setting section 103, a second mode switching determination section 104, a reference distance change mode setting section 105, and a third mode switching determination section 106.

The imaging mode setting section 101 sets the imaging mode as an initial setting of the operation mode of the imaging apparatus 10.

The first mode switching determination section 102 determines whether or not a first mode switching condition for switching the operation mode of the imaging apparatus 10 from the imaging mode to the image adjustment mode is established. As an example of the first mode switching condition, for example, a condition that a first mode switching instruction for switching the operation mode of the imaging apparatus 10 from the imaging mode to the image adjustment mode is received by the reception device 76, or the like is included. In a case where the first mode switching instruction is received by the reception device 76, a first mode switching instruction signal indicating the first mode switching instruction is output from the reception device 76 to the CPU 62. In a case where the first mode switching instruction signal is input to the CPU 62, the first mode switching determination section 102 determines that the first mode switching condition for switching the operation mode of the imaging apparatus 10 from the imaging mode to the image adjustment mode is established.

In a case where the first mode switching determination section 102 determines that the first mode switching condition is established, the image adjustment mode setting section 103 sets the image adjustment mode as the operation mode of the imaging apparatus 10.

The second mode switching determination section 104 determines whether or not a second mode switching condition for switching the operation mode of the imaging apparatus 10 from the imaging mode or the image adjustment mode to the reference distance change mode is established. As an example of the second mode switching condition, for example, a condition that a second mode switching instruction for switching the operation mode of the imaging apparatus 10 from the imaging mode or the image adjustment mode to the reference distance change mode is received by the reception device 76, or the like is included. In a case where the second mode switching instruction is received by the reception device 76, a second mode switching instruction signal indicating the second mode switching instruction is output from the reception device 76 to the CPU 62. In a case where the second mode switching instruction signal is input to the CPU 62, the second mode switching determination section 104 determines that the second mode switching condition for switching the operation mode of the imaging apparatus 10 from the imaging mode or the image adjustment mode to the reference distance change mode is established.

In a case where the second mode switching determination section 104 determines that the second mode switching condition is established, the reference distance change mode setting section 105 sets the reference distance change mode as the operation mode of the imaging apparatus 10.

The third mode switching determination section 106 determines whether or not the operation mode of the imaging apparatus 10 is the image adjustment mode or the reference distance change mode. In a case where it is determined that the operation mode of the imaging apparatus 10 is the image adjustment mode or the reference distance change mode, the third mode switching determination section 106 determines whether or not a third mode switching condition for switching the operation mode of the imaging apparatus 10 from the image adjustment mode or the reference distance change mode to the imaging mode is established. As an example of the third mode switching condition, for example, a condition that a third mode switching instruction for switching the operation mode of the imaging apparatus 10 from the image adjustment mode or the reference distance change mode to the imaging mode is received by the reception device 76, or the like is included. In a case where the third mode switching instruction is received by the reception device 76, a third mode switching instruction signal indicating the third mode switching instruction is output from the reception device 76 to the CPU 62. In a case where the third mode switching instruction signal is input to the CPU 62, the third mode switching determination section 106 determines that the third mode switching condition for switching the operation mode of the imaging apparatus 10 from the image adjustment mode or the reference distance change mode to the imaging mode is established.

In a case where the third mode switching determination section 106 determines that the third mode switching condition is established, the imaging mode setting section 101 sets the imaging mode as the operation mode of the imaging apparatus 10.

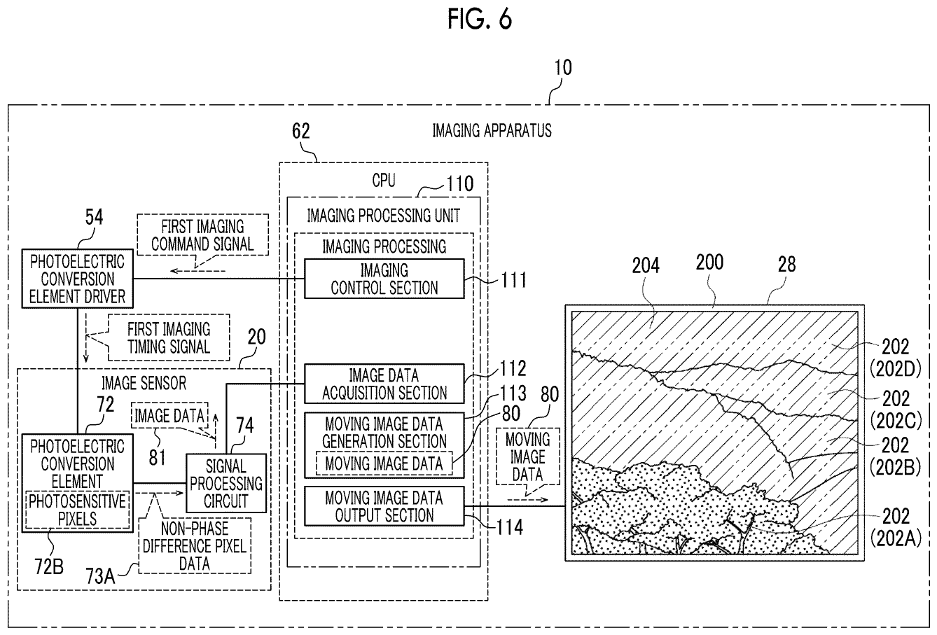

As shown in FIG. 6 as an example, the imaging processing unit 110 performs imaging processing for outputting the moving image data 80 based on the image data 81 obtained by causing the image sensor 20 to image the subject 202. The imaging processing unit 110 has an imaging control section 111, an image data acquisition section 112, a moving image data generation section 113, and a moving image data output section 114.

The imaging control section 111 controls the photoelectric conversion element 72 to output the non-phase difference pixel data 73A. Specifically, the imaging control section 111 outputs, to the photoelectric conversion element driver 54, a first imaging command signal for causing the photoelectric conversion element 72 to output a first imaging timing signal as the imaging timing signal. The first imaging timing signal is an imaging timing signal for causing the photoelectric conversion element 72 to output the non-phase difference pixel data 73A. Each photosensitive pixel 72B of the photoelectric conversion element 72 outputs the non-phase difference pixel data 73A by performing photoelectric conversion on the entire region of the photosensitive pixel 72B in accordance with the first imaging timing signal. The photoelectric conversion element 72 outputs the non-phase difference pixel data 73A output from each photosensitive pixel 72B to the signal processing circuit 74. The signal processing circuit 74 digitizes the non-phase difference pixel data 73A output from each photosensitive pixel 72B to generate the image data 81.

The image data acquisition section 112 acquires the image data 81 from the signal processing circuit 74. The image data 81 is data indicating an image 200 obtained by imaging a plurality of subjects 202 with the image sensor 20.

The moving image data generation section 113 generates the moving image data 80 based on the image data 81 acquired by the image data acquisition section 112.

The moving image data output section 114 outputs the moving image data 80 generated by the moving image data generation section 113 to the display 28 at a predetermined frame rate (for example, 30 frames/second). The display 28 displays an image based on the moving image data 80.

In the example shown in FIG. 6, the image 200 is a landscape image. The plurality of subjects 202 (as an example, four subjects 202) appear as images in the image 200. Hereinafter, in a case where the plurality of subjects 202 are distinguished from each other for description, the plurality of subjects 202 are referred to as a first subject 202A, a second subject 202B, a third subject 202C, and a fourth subject 202D, respectively. As an example, the first subject 202A is trees, and the second subject 202B, the third subject 202C, and the fourth subject 202D are each a mountain. The first subject 202A, the second subject 202B, the third subject 202C, and the fourth subject 202D exist at positions where distances from the imaging apparatus 10 become longer in the order of the first subject 202A, the second subject 202B, the third subject 202C, and the fourth subject 202D. As an example, the second subject 202B, the third subject 202C, and the fourth subject 202D are covered in mist 204, and the mist 204 appears as an image in the image 200. In the example shown in FIG. 6, the mist 204 is represented by hatching.

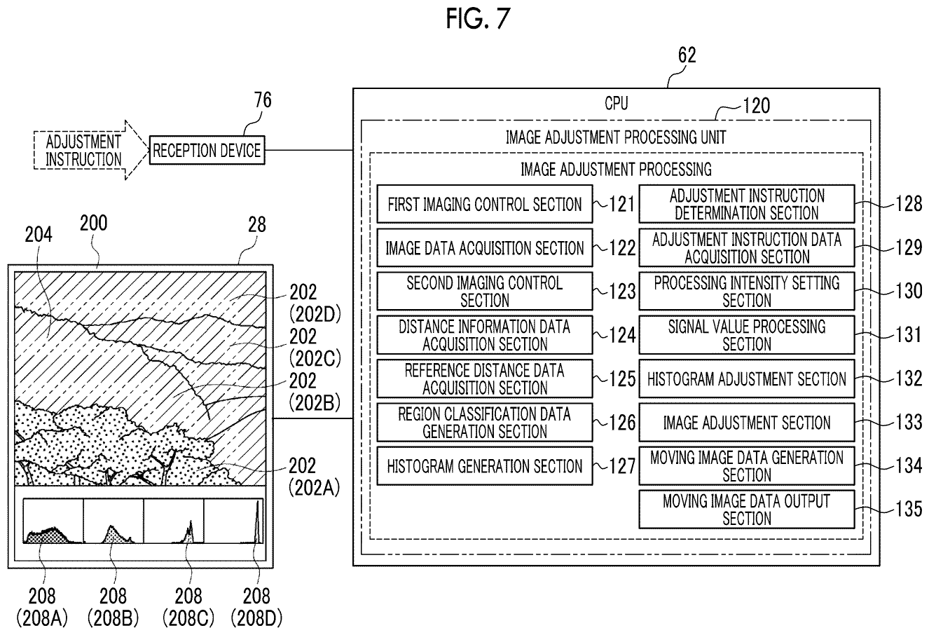

As shown in FIG. 7 as an example, the image adjustment processing unit 120 performs image adjustment processing for adjusting a histogram 208, which will be described below, and the image 200 based on an adjustment instruction received by the reception device 76. The image adjustment processing unit 120 has a first imaging control section 121, an image data acquisition section 122, a second imaging control section 123, a distance information data acquisition section 124, a reference distance data acquisition section 125, a region classification data generation section 126, a histogram data generation section 127, an adjustment instruction determination section 128, an adjustment instruction data acquisition section 129, a processing intensity setting section 130, a signal value processing section 131, a histogram adjustment section 132, an image adjustment section 133, a moving image data generation section 134, and a moving image data output section 135.

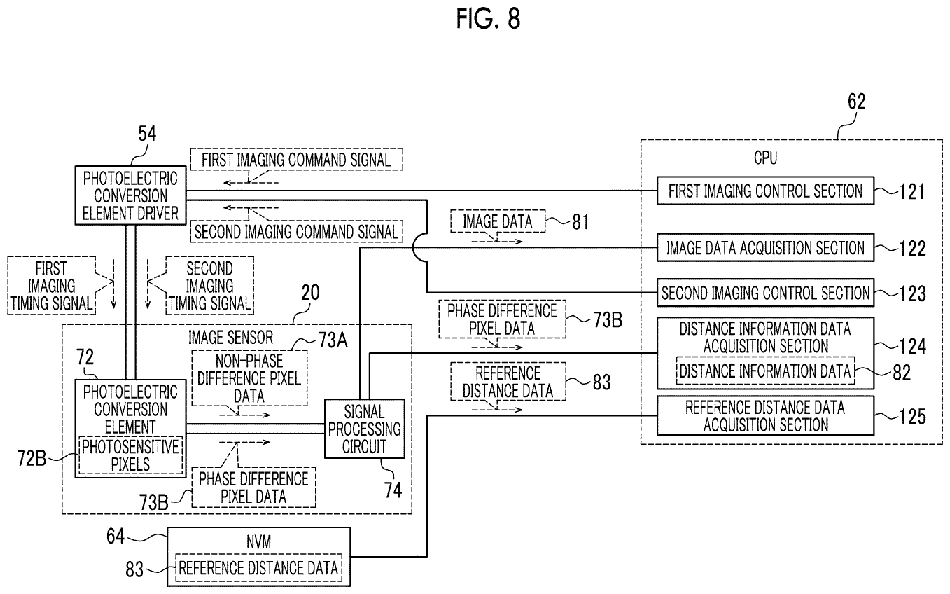

As shown in FIG. 8 as an example, the first imaging control section 121 controls the photoelectric conversion element 72 to output the non-phase difference pixel data 73A. Specifically, the first imaging control section 121 outputs, to the photoelectric conversion element driver 54, a first imaging command signal for causing the photoelectric conversion element 72 to output a first imaging timing signal as the imaging timing signal. The first imaging timing signal is an imaging timing signal for causing the photoelectric conversion element 72 to output the non-phase difference pixel data 73A. Each photosensitive pixel 72B of the photoelectric conversion element 72 outputs the non-phase difference pixel data 73A by performing photoelectric conversion on the entire region of the photosensitive pixel 72B in accordance with the first imaging timing signal. The photoelectric conversion element 72 outputs the non-phase difference pixel data 73A output from each photosensitive pixel 72B to the signal processing circuit 74. The signal processing circuit 74 digitizes the non-phase difference pixel data 73A output from each photosensitive pixel 72B to generate the image data 81.

The image data 81 is an example of “first image data” according to the technology of the present disclosure. The image data acquisition section 122 acquires the image data 81 from the signal processing circuit 74.

The second imaging control section 123 controls the photoelectric conversion element 72 to output the phase difference pixel data 73B. Specifically, the second imaging control section 123 outputs, to the photoelectric conversion element driver 54, a second imaging command signal for causing the photoelectric conversion element 72 to output a second imaging timing signal as the imaging timing signal. The second imaging timing signal is an imaging timing signal for causing the photoelectric conversion element 72 to output the phase difference pixel data 73B. Each photosensitive pixel 72B of the photoelectric conversion element 72 outputs the phase difference pixel data 73B by performing photoelectric conversion on a partial region of the photosensitive pixel 72B in accordance with the second imaging timing signal. The photoelectric conversion element 72 outputs the phase difference pixel data 73B obtained from each photosensitive pixel 72B to the signal processing circuit 74. The signal processing circuit 74 digitizes the phase difference pixel data 73B and outputs the digitized phase difference pixel data 73B to the distance information data acquisition section 124.

The distance information data acquisition section 124 acquires the distance information data 82. Specifically, the distance information data acquisition section 124 acquires the phase difference pixel data 73B from the signal processing circuit 74 and generates the distance information data 82 indicating the distance information regarding the subject distance corresponding to each photosensitive pixel 72B based on the acquired phase difference pixel data 73B.

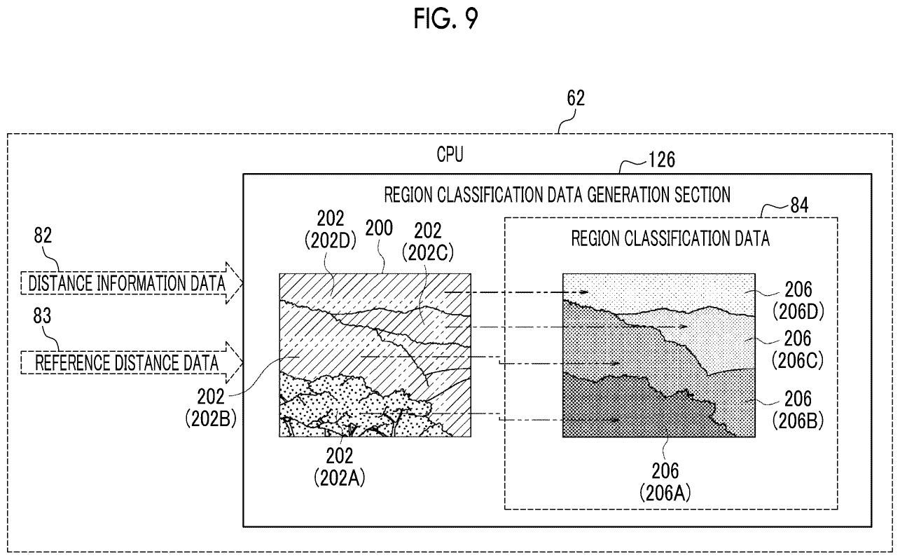

The reference distance data acquisition section 125 acquires reference distance data 83 stored in advance in the NVM 64. The reference distance data 83 is data indicating reference distances for classifying the image 200 (see FIG. 9) based on the image data 81 into a plurality of regions 206 (see FIG. 9) according to the subject distances.

As shown in FIG. 9 as an example, the region classification data generation section 126 generates region classification data 84 for classifying the image 200 into the plurality of regions 206 (as an example, four regions 206) according to the subject distances, based on the distance information data 82 and the reference distance data 83.

The region classification data 84 is data indicating the plurality of regions 206. The plurality of regions 206 are classified for each subject distance based on the reference distances (as an example, three reference distances) indicated by the reference distance data. Hereinafter, in a case where the plurality of regions 206 are distinguished from each other for description, the plurality of regions 206 are referred to as a first region 206A, a second region 206B, a third region 206C, and a fourth region 206D, respectively.

In the example shown in FIG. 9, the subject distances corresponding to the respective regions 206 become longer in the order of the first region 206A, the second region 206B, the third region 206C, and the fourth region 206D. The first region 206A and the second region 206B are regions classified based on a first reference distance among a plurality of reference distances. The second region 206B and the third region 206C are regions classified based on a second reference distance among the plurality of reference distances. The third region 206C and the fourth region 206D are regions classified based on a third reference distance among the plurality of reference distances. The first region 206A is a region corresponding to the first subject 202A, the second region 206B is a region corresponding to the second subject 202B, the third region 206C is a region corresponding to the third subject 202C, and the fourth region 206D is a region corresponding to the fourth subject 202D.

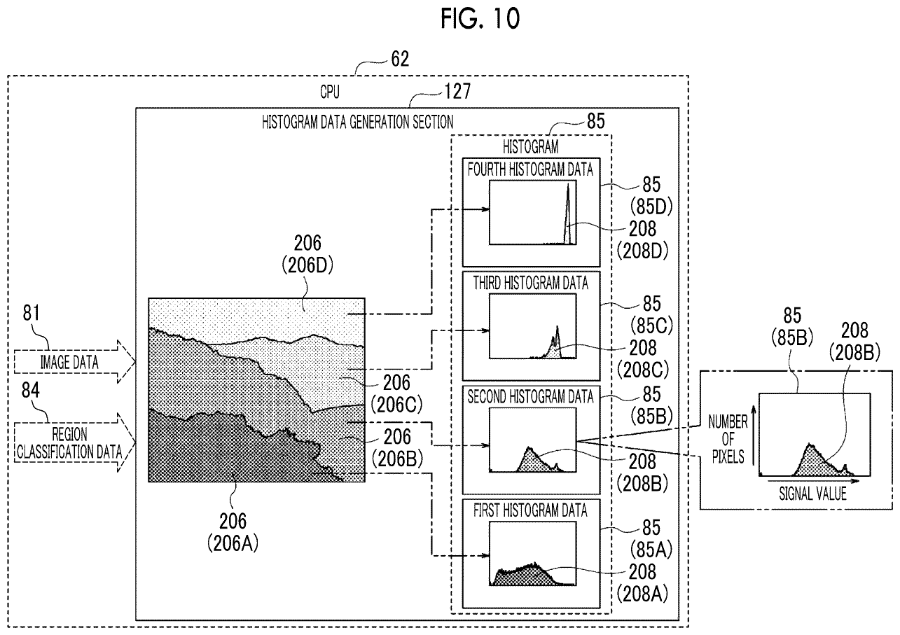

As shown in FIG. 10 as an example, the histogram data generation section 127 generates histogram data 85 corresponding to each region 206 based on the image data 81 and the region classification data 84. The histogram data 85 is data indicating the histogram 208 corresponding to each region 206. The histogram data 85 has first histogram data 85A, second histogram data 85B, third histogram data 85C, and fourth histogram data 85D. Hereinafter, in a case where the histograms 208 corresponding to the respective regions 206 are distinguished from each other for description, the plurality of histograms 208 are referred to as a first histogram 208A, a second histogram 208B, a third histogram 208C, and a fourth histogram 208D, respectively.

The first histogram data 85A is data indicating the first histogram 208A corresponding to the first region 206A. The second histogram data 85B is data indicating the second histogram 208B corresponding to the second region 206B. The third histogram data 85C is data indicating the third histogram 208C corresponding to the third region 206C. The fourth histogram data 85D is data indicating the fourth histogram 208D corresponding to the fourth region 206D.

Each histogram 208 is a histogram created based on the signal of the image data 81 for each region 206. The signal of the image data 81 refers to a collection of signal values (that is, a signal value group). That is, the first histogram 208A is created based on a first signal (that is, a first signal group) corresponding to the first region 206A. The second histogram 208B is created based on a second signal (that is, a second signal group) corresponding to the second region 206B. The third histogram 208C is created based on a third signal (that is, a third signal group) corresponding to the third region 206C. The fourth histogram 208D is created based on a fourth signal (that is, a fourth signal group) corresponding to the fourth region 206D.

As an example, each histogram 208 is a histogram indicating a relationship between a signal value and the number of pixels for each region 206. The number of pixels refers to the number of a plurality of pixels forming the image 200 (hereinafter, referred to as image pixels).

In the example shown in FIG. 10, the signal value increases from the first region 206A toward the fourth region 206D. Therefore, it can be confirmed from the plurality of histograms 208 that the first region 206A is not covered in the mist 204 (see FIG. 7), and the density of the mist 204 increases from the second region 206B toward the fourth region 206D.

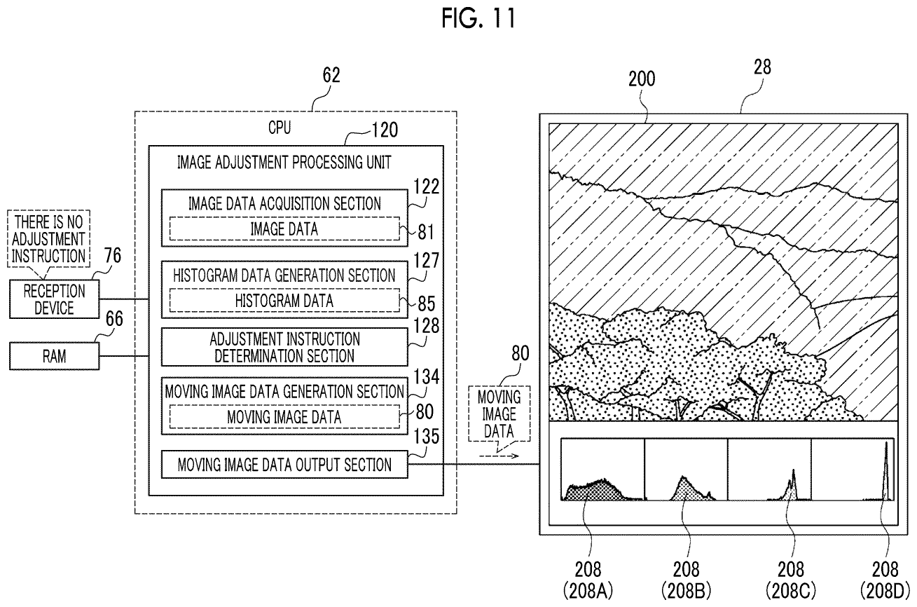

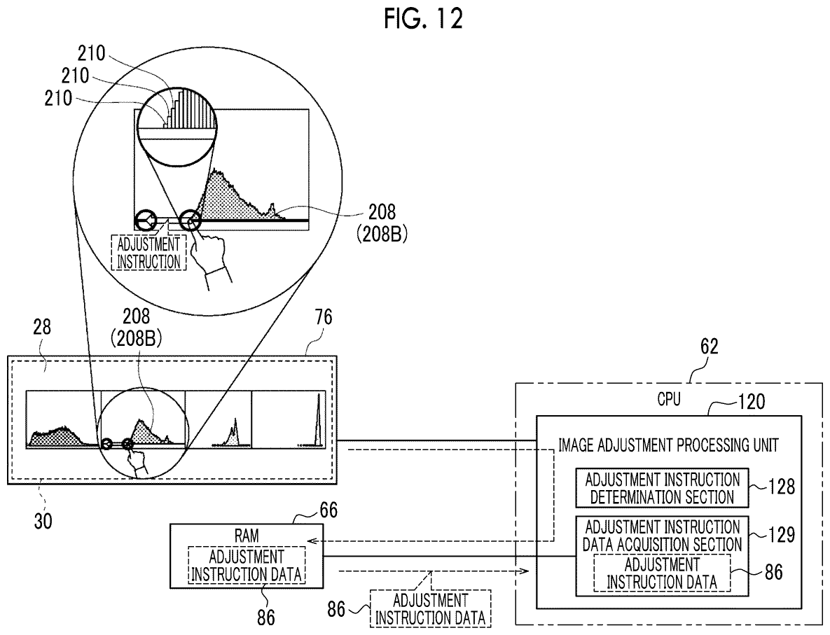

As an example, FIG. 11 shows an example of a case where the adjustment instruction for adjusting the histogram 208 and the image 200 is not received by the reception device 76. The adjustment instruction is an instruction to change the form of any histogram 208 among the plurality of histograms 208. In a case where the adjustment instruction is received by the reception device 76, adjustment instruction data 86 (see FIG. 12) is stored in the RAM 66, but in a case where no adjustment instruction is received by the reception device 76, the adjustment instruction data 86 is not stored in the RAM 66. The adjustment instruction determination section 128 determines whether or not the adjustment instruction data 86 is stored in the RAM 66.

In a case where the adjustment instruction determination section 128 determines that the adjustment instruction data 86 indicating the adjustment instruction is not stored in the RAM 66, the moving image data generation section 134 generates the moving image data 80 including the image data 81 acquired by the image data acquisition section 122 and the histogram data 85 generated by the histogram data generation section 127.

The moving image data output section 135 outputs the moving image data 80 generated by the moving image data generation section 134 to the display 28. The display 28 displays an image based on the moving image data 80. In the example shown in FIG. 11, the image 200 indicated by the image data 81 and the plurality of histograms 208 indicated by the histogram data 85 are displayed on the display 28. The image 200 is an example of a “first image” according to the technology of the present disclosure.

As an example, FIG. 12 shows an example of a case where the adjustment instruction is received by the reception device 76. As an example, the adjustment instruction is an instruction to change the form of the histogram 208 displayed on the display 28 through the touch panel 30. Hereinafter, an example in which the form of the second histogram 208B is changed by the adjustment instruction will be described as an example.

The second histogram 208B has a plurality of bins 210. The adjustment instruction is an example of an instruction to change the form of the second histogram 208B. To describe the adjustment instruction in more detail, the adjustment instruction is an instruction to select a signal value from the plurality of bins 210 and to move the bin 210 corresponding to the selected signal value. In the example shown in FIG. 12, an instruction to move the bin 210 by swiping on the touch panel 30 is shown as an example of the adjustment instruction. In addition, in the example shown in FIG. 12, an aspect is shown in which the bin 210 is moved in a direction in which the signal value selected based on the adjustment instruction received by the reception device 76 becomes smaller than that before the adjustment instruction is received by the reception device 76. Hereinafter, in a case where it is necessary to distinguish the adjustment instruction of the aspect shown in FIG. 12 from the adjustment instruction of the other aspect for description, the adjustment instruction of the aspect shown in FIG. 12 is referred to as a minus-side swipe instruction.

The adjustment instruction is an example of a “first instruction” according to the technology of the present disclosure. The second histogram 208B is an example of “first brightness information”, a “first histogram”, and a “second histogram” according to the technology of the present disclosure. The plurality of bins 210 are an example of a “plurality of bins” according to the technology of the present disclosure. The signal value selected based on the adjustment instruction is an example of a “third signal value” according to the technology of the present disclosure.

In a case where the adjustment instruction is received by the reception device 76, the image adjustment processing unit 120 stores the adjustment instruction data 86 indicating the adjustment instruction in the RAM 66. Specifically, data indicating the signal value selected based on the adjustment instruction and the movement amount of the bin 210 is stored in the RAM 66 as the adjustment instruction data 86. The movement amount of the bin 210 corresponds to a difference between the signal value corresponding to the bin 210 before the movement and the signal value corresponding to the bin 210 after the movement.

In a case where the adjustment instruction determination section 128 determines that the adjustment instruction data 86 indicating the adjustment instruction is stored in the RAM 66, the adjustment instruction data acquisition section 129 acquires the adjustment instruction data 86 stored in the RAM 66.

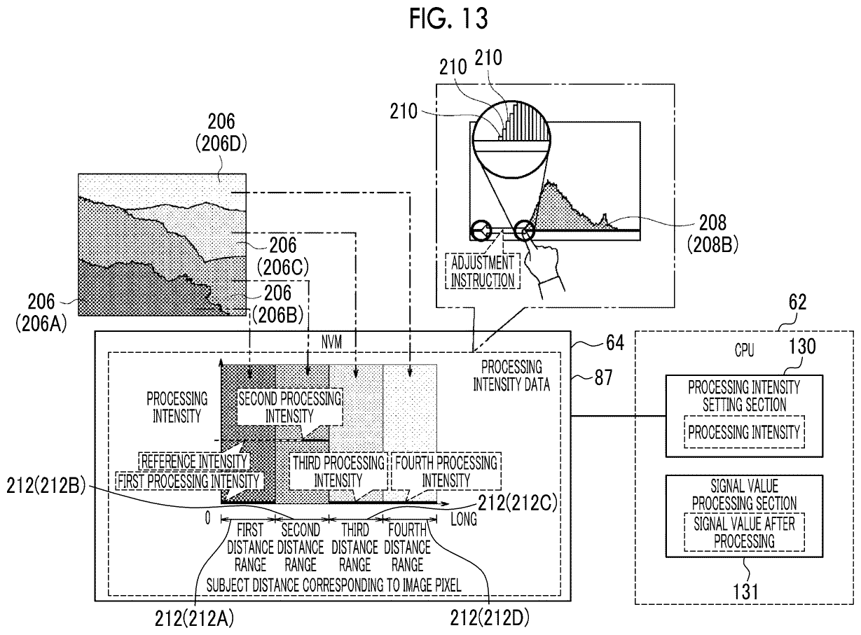

As shown in FIG. 13 as an example, processing intensity data 87 is stored in the NVM 64. The processing intensity data 87 is data indicating a relationship between a subject distance corresponding to the image pixel and processing intensity. The processing intensity refers to a change amount of the signal value changed based on the adjustment instruction for each image pixel. Reference intensity refers to a change amount of the signal value selected based on the adjustment instruction (that is, a difference between the signal value corresponding to the bin 210 before the movement and the signal value corresponding to the bin 210 after the movement). In the description of the processing intensity with reference to FIG. 13, the processing refers to changing the signal value based on the adjustment instruction.

The processing intensity data 87 corresponding to each histogram 208 is stored in the NVM 64. As an example, the processing intensity data 87 shown in FIG. 13 indicates data in a case where the form of the second histogram 208B is changed based on the adjustment instruction.

In the processing intensity data 87, a range of the subject distances is classified into a plurality of distance ranges 212. Hereinafter, in a case where the plurality of distance ranges 212 are distinguished from each other for description, the plurality of distance ranges 212 are referred to as a first distance range 212A, a second distance range 212B, a third distance range 212C, and a fourth distance range 212D, respectively. The first distance range 212A is a range of subject distances corresponding to the first region 206A. The second distance range 212B is a range of subject distances corresponding to the second region 206B. The third distance range 212C is a range of subject distances corresponding to the third region 206C. The fourth distance range 212D is a range of subject distances corresponding to the fourth region 206D. The plurality of distance ranges 212 are ranges in which the subject distance becomes longer in the order of the first distance range 212A, the second distance range 212B, the third distance range 212C, and the fourth distance range 212D.

The processing intensity is set for each of the plurality of distance ranges 212. Hereinafter, the processing intensity corresponding to the first distance range 212A is referred to as first processing intensity, the processing intensity corresponding to the second distance range 212B is referred to as second processing intensity, the processing intensity corresponding to the third distance range 212C is referred to as third processing intensity, and the processing intensity corresponding to the fourth distance range 212D is referred to as fourth processing intensity.

In the example shown in FIG. 13, the second processing intensity is set to a constant value corresponding to the reference intensity. That is, for each image pixel corresponding to the second distance range 212B, the change amount of the signal value changed based on the adjustment instruction is constant. In addition, in the example shown in FIG. 13, the first processing intensity, the third processing intensity, and the fourth processing intensity are set to zero. That is, the change amount of the signal value is zero for each image pixel corresponding to the first distance range 212A, the third distance range 212C, and the fourth distance range 212D.

The processing intensity setting section 130 sets the processing intensity corresponding to each image pixel based on the processing intensity data 87. In the example shown in FIG. 13, the processing intensity is set to the reference intensity for the image pixels corresponding to the second distance range 212B, and the processing intensity is set to zero for the image pixels corresponding to the first distance range 212A, the third distance range 212C, and the fourth distance range 212D.

The signal value processing section 131 calculates a signal value after processing for each image pixel based on the processing intensity set by the processing intensity setting section 130. As an example, in a case where the adjustment instruction is an instruction to move the bin 210 in a direction in which the signal value becomes smaller than that before the adjustment instruction is received by the reception device 76, the signal value processing section 131 calculates the signal value corresponding to each image pixel by using Equations (1) and (2). Note that Equation (2) is applied to a case where Value₁<Black.

$${Value}_{1} = \{ ( {Value}_{0} - {Sel}_{0} ) \times \frac{( White - {Sel}_{1} )}{( White - {Sel}_{0} )} \} + {Sel}_{1} \qquad ( 1 )$$

$${Value}_{1} = Black \qquad ( 2 )$$

Value₀ is a signal value before processing corresponding to each image pixel (hereinafter, referred to as a signal value before processing). Value₁ is a signal value after processing corresponding to each image pixel (hereinafter, referred to as a signal value after processing). Sel₀ is a value before processing of the signal value selected based on the adjustment instruction. Sel₁ is a value after processing of the signal value selected based on the adjustment instruction. Black is a minimum value of the signal value (hereinafter, referred to as a minimum signal value). White is a maximum value of the signal value (hereinafter, referred to as a maximum signal value). The signal value before processing corresponds to a signal value before adjustment in accordance with the adjustment instruction. Additionally, the signal value after processing corresponds to a signal value after adjustment in accordance with the adjustment instruction.

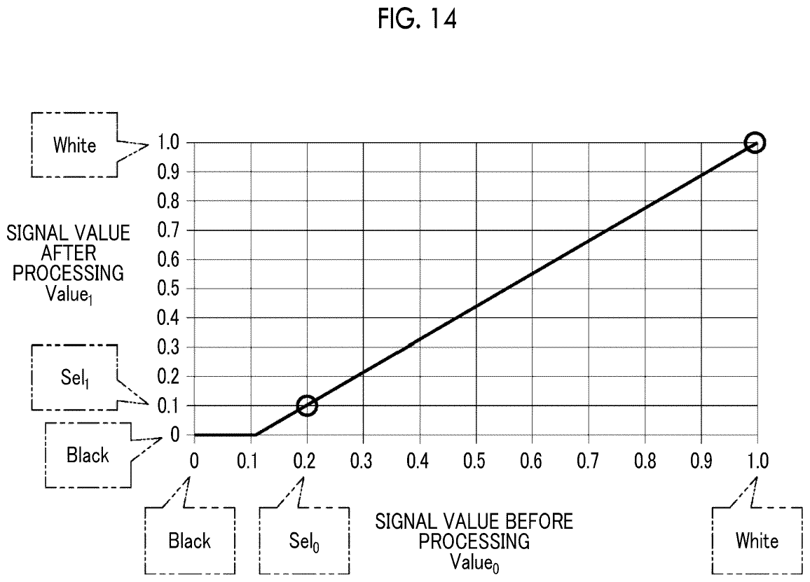

As an example, FIG. 14 shows a graph showing a relationship between a signal value before processing and a signal value after processing in a case where the minus-side swipe instruction is received by the reception device 76. In the example shown in FIG. 14, the value Sel₀ before processing of the signal value selected based on the minus-side swipe instruction is 0.2, and the value Sel₁ after processing of the signal value selected based on the minus-side swipe instruction is 0.1. The minimum signal value Black is 0, and the maximum signal value White is 1.0. In a case where the signal value before processing is 0.2, the signal value after processing is 0.1. The maximum signal value remains at 1.0 before and after the processing.

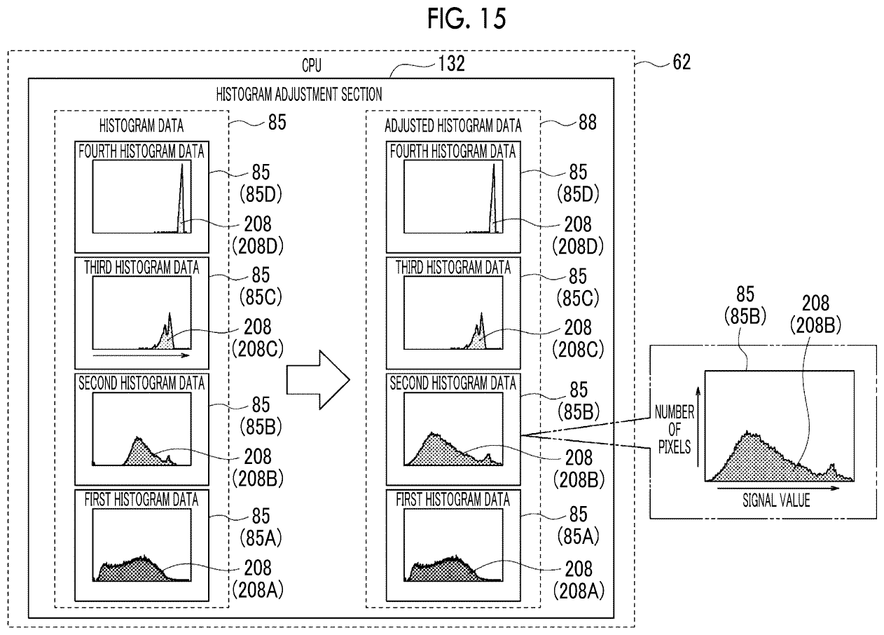

As shown in FIG. 15 as an example, the histogram adjustment section 132 performs processing of reflecting the content of the adjustment instruction in at least one histogram 208 of the plurality of histograms 208. Specifically, the histogram adjustment section 132 generates adjusted histogram data 88 in which the content of the adjustment instruction is reflected in at least one histogram 208 of the plurality of histograms 208, based on the signal value calculated by the signal value processing section 131 (see FIG. 13). The adjusted histogram data 88 is data indicating the plurality of histograms 208 including the histogram 208 of which the form is changed in accordance with the adjustment instruction.

The histogram 208 of which the form is changed in accordance with the adjustment instruction is a histogram indicating a relationship between the signal value after processing and the number of pixels. As an example, FIG. 15 shows an example in which the form of the second histogram 208B is changed in accordance with the minus-side swipe instruction. Due to the minus-side swipe instruction, the shape of the second histogram 208B changes to a lower signal value than that before the minus-side swipe instruction is received by the reception device 76.

In the examples shown in FIGS. 12 to 15, the processing intensity of the second distance range 212B corresponding to the second histogram 208B is set to a value larger than zero (see FIG. 13). Therefore, the content of the adjustment instruction for the second histogram 208B is reflected in the second histogram 208B. The adjusted histogram data 88 shown in FIG. 15 includes the second histogram data 85B indicating the second histogram 208B in which the content of the adjustment instruction is reflected.

Meanwhile, in the examples shown in FIGS. 12 to 15, the processing intensity of the first distance range 212A corresponding to the first histogram 208A, the processing intensity of the third distance range 212C corresponding to the third histogram 208C, and the processing intensity of the fourth distance range 212D corresponding to the fourth histogram 208D are all set to zero (see FIG. 13). Therefore, the content of the adjustment instruction for the second histogram 208B is prohibited from being reflected in the first histogram 208A, the third histogram 208C, and the fourth histogram 208D. The adjusted histogram data 88 shown in FIG. 15 includes the first histogram data 85A, the third histogram data 85C, and the fourth histogram data 85D included in the histogram data 85 as they are.

The examples shown in FIGS. 12 to 15 are examples in which the form of the second histogram 208B is changed in accordance with the adjustment instruction, but in a case where the adjustment instruction is an instruction to change the form of the first histogram 208A, the form of the first histogram 208A is changed in accordance with the adjustment instruction. Similarly, in a case where the adjustment instruction is an instruction to change the form of the third histogram 208C, the form of the third histogram 208C is changed in accordance with the adjustment instruction, and in a case where the adjustment instruction is an instruction to change the form of the fourth histogram 208D, the form of the fourth histogram 208D is changed in accordance with the adjustment instruction.

The processing of generating the adjusted histogram data 88 through the histogram adjustment section 132 is an example of “first processing” according to the technology of the present disclosure. Within the processing executed by the histogram adjustment section 132, the processing of prohibiting the content of the adjustment instruction for the second histogram 208B from being reflected in the first histogram 208A, the third histogram 208C, and the fourth histogram 208D is an example of “second processing” according to the technology of the present disclosure.

The second region 206B is an example of a “first region” according to the technology of the present disclosure. The first region 206A, the third region 206C, and the fourth region 206D are examples of a “second region” according to the technology of the present disclosure. The signal corresponding to the second distance range 212B is an example of a “first signal” according to the technology of the present disclosure. The signals corresponding to the first distance range 212A, the third distance range 212C, and the fourth distance range 212D are examples of a “second signal” according to the technology of the present disclosure.

The second histogram 208B is an example of “first brightness information” according to the technology of the present disclosure. The second histogram data 85B is an example of “first brightness information data” according to the technology of the present disclosure. The first histogram 208A, the third histogram 208C, and the fourth histogram 208D are examples of “second brightness information” according to the technology of the present disclosure. The first histogram data 85A, the third histogram data 85C, and the fourth histogram data 85D are examples of “second brightness information data” according to the technology of the present disclosure.

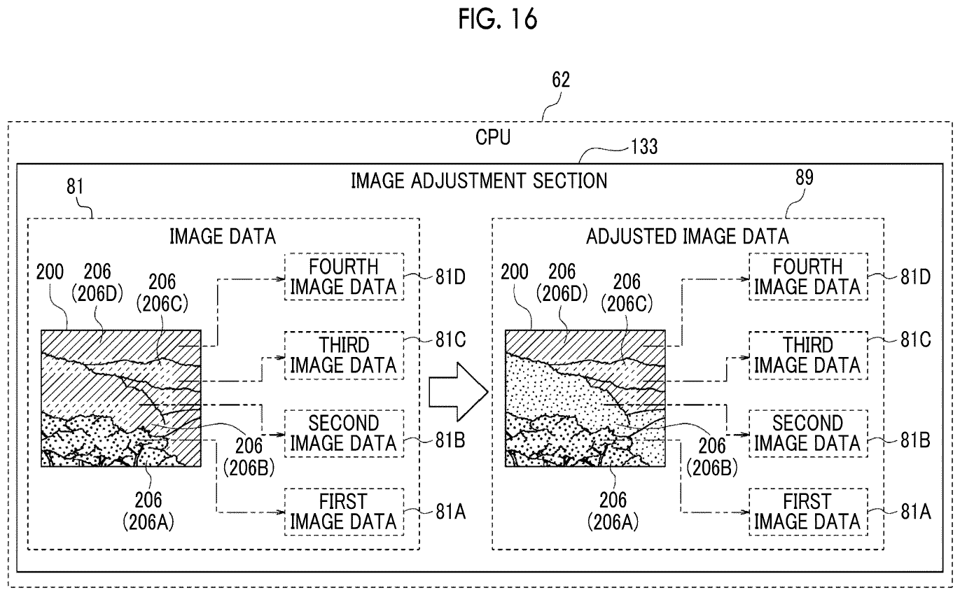

As shown in FIG. 16 as an example, the image data 81 includes first image data 81A, second image data 81B, third image data 81C, and fourth image data 81D. The first image data 81A is data corresponding to the first region 206A. The second image data 81B is data corresponding to the second region 206B. The third image data 81C is data corresponding to the third region 206C. The fourth image data 81D is data corresponding to the fourth region 206D.

The image adjustment section 133 performs processing of reflecting the content of the adjustment instruction in the image 200. Specifically, the image adjustment section 133 generates adjusted image data 89 in which the content of the adjustment instruction is reflected in at least one region 206 of the plurality of regions 206, based on the signal value calculated by the signal value processing section 131 (see FIG. 13). The adjusted image data 89 is data in which the signal value is changed in accordance with the adjustment instruction with respect to the image data 81.

In the example shown in FIG. 16, the adjusted image data 89 includes the second image data 81B in which the signal value is changed in accordance with the adjustment instruction. That is, the signal value included in the second image data 81B is a signal value after processing.

In the examples shown in FIGS. 12 to 16, the processing intensity of the second distance range 212B corresponding to the second region 206B is set to a value larger than zero (see FIG. 13). Therefore, the content of the adjustment instruction for the second histogram 208B is reflected in the second region 206B. The adjusted image data 89 shown in FIG. 16 includes the second image data 81B indicating the second region 206B in which the content of the adjustment instruction is reflected.

Meanwhile, in the examples shown in FIGS. 12 to 16, the processing intensity of the first distance range 212A corresponding to the first region 206A, the processing intensity of the third distance range 212C corresponding to the third region 206C, and the processing intensity of the fourth distance range 212D corresponding to the fourth region 206D are all set to zero (see FIG. 13). Therefore, the content of the adjustment instruction for the second region 206B is prohibited from being reflected in the first region 206A, the third region 206C, and the fourth region 206D. The adjusted image data 89 shown in FIG. 16 includes the first image data 81A, the third image data 81C, and the fourth image data 81D included in the image data 81 as they are.

The examples shown in FIGS. 12 to 16 are examples in which the form of the second histogram 208B is changed in accordance with the adjustment instruction to change the signal value of the second image data 81B, but in a case where the adjustment instruction is an instruction to change the form of the first histogram 208A, the signal value of the first image data 81A is changed in accordance with the adjustment instruction. Similarly, in a case where the adjustment instruction is an instruction to change the form of the third histogram 208C, the signal value of the third image data 81C is changed in accordance with the adjustment instruction, and in a case where the adjustment instruction is an instruction to change the form of the fourth histogram 208D, the signal value of the fourth image data 81D is changed in accordance with the adjustment instruction.

The processing of generating the adjusted image data 89 through the image adjustment section 133 is an example of “first processing” according to the technology of the present disclosure. Within the processing executed by the image adjustment section 133, the processing of prohibiting the content of the adjustment instruction for the second histogram 208B from being reflected in the first region 206A, the third region 206C, and the fourth region 206D is an example of “second processing” according to the technology of the present disclosure.

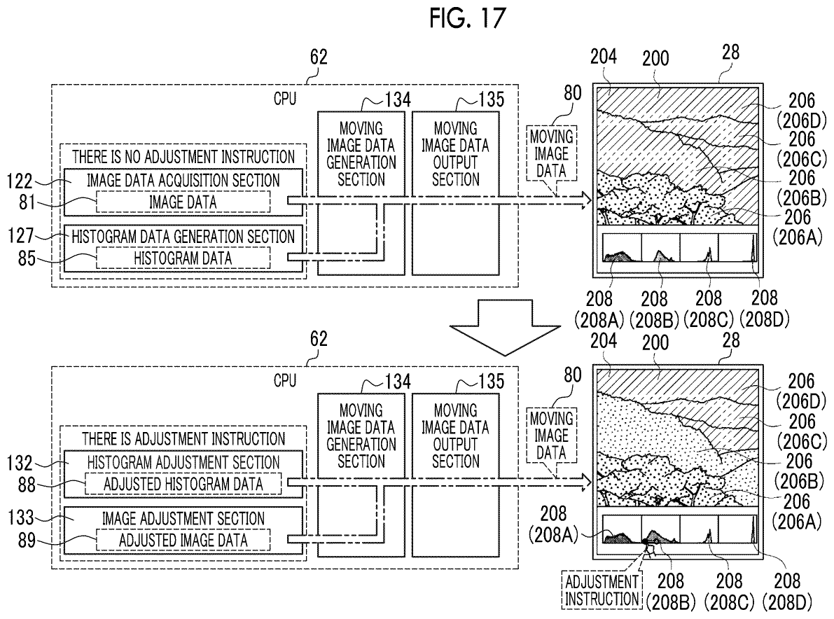

As an example, FIG. 17 shows a state where the image 200 and the histogram 208 change in a case where a state before the adjustment instruction is received by the reception device 76 transitions to a state after the adjustment instruction is received by the reception device 76.

As shown in FIG. 17 as an example, the moving image data generation section 134 generates the moving image data 80 including the image data 81 and the histogram data 85 in a case where no adjustment instruction is received by the reception device 76, but generates the moving image data 80 including the adjusted image data 89 and the adjusted histogram data 88 in a case where the adjustment instruction is received by the reception device 76.

The moving image data output section 135 outputs the moving image data 80 generated by the moving image data generation section 134 to the display 28. The display 28 displays an image based on the moving image data 80.

In the example shown in FIG. 17, the form of the second histogram 208B is changed based on the adjustment instruction. In other words, a display aspect of the second histogram 208B displayed on the display 28 is changed. Further, by changing the signal value corresponding to the second region 206B based on the adjustment instruction, the display aspect of the second region 206B displayed on the display 28 is changed. In the example shown in FIG. 17, by changing the signal value corresponding to the second region 206B in accordance with the minus-side swipe instruction as the adjustment instruction, the brightness of the second region 206B becomes darker than that before the minus-side swipe instruction is received by the reception device 76, and the mist 204 appearing in the second region 206B is suppressed.

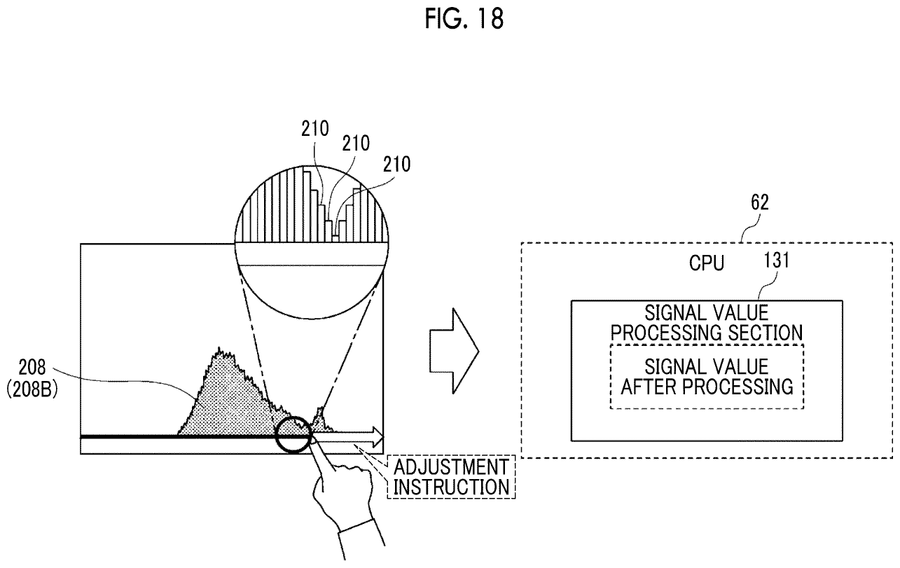

As shown in FIG. 18 as an example, the adjustment instruction may be an instruction to move the bin 210 in a direction in which the signal value selected based on the adjustment instruction becomes larger than that before the adjustment instruction is received by the reception device 76. Hereinafter, in a case where it is necessary to distinguish the adjustment instruction of the aspect shown in FIG. 18 from the adjustment instruction of the other aspect for description, the adjustment instruction of the aspect shown in FIG. 18 is referred to as a plus-side swipe instruction. In a case where the adjustment instruction is the plus-side swipe instruction, the signal value processing section 131 calculates the signal value corresponding to each image pixel by using Equations (3) and (4). Note that Equation (4) is applied to a case where Value₁>White.

$${Value}_{1} = {Value}_{0} \times \frac{{Sel}_{1}}{{Sel}_{0}} \qquad ( 3 )$$

$${Value}_{1} = White \qquad ( 4 )$$

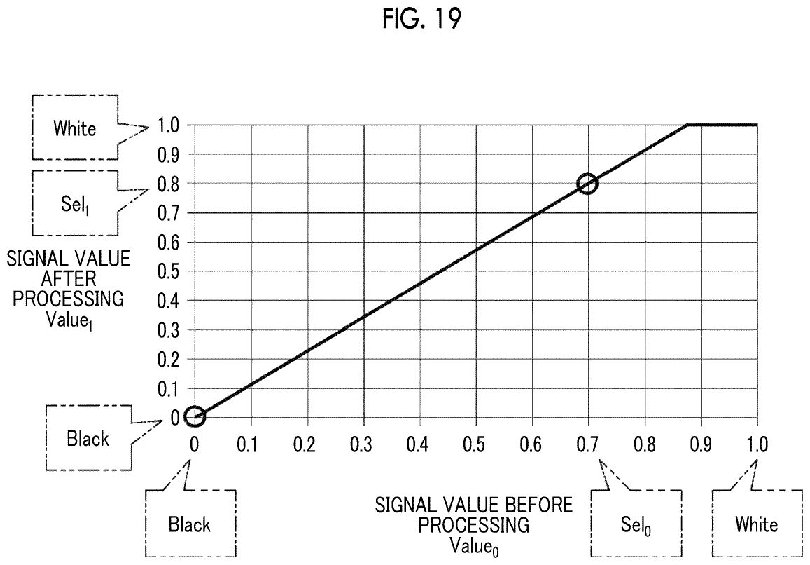

As an example, FIG. 19 shows a graph showing a relationship between a signal value before processing and a signal value after processing in a case where the plus-side swipe instruction is received by the reception device 76. In the example shown in FIG. 19, the value Sel₀ before processing of the signal value selected based on the plus-side swipe instruction is 0.7, and the value Sel₁ after processing of the signal value selected based on the plus-side swipe instruction is 0.8. The minimum signal value Black is 0, and the maximum signal value White is 1.0. In a case where the signal value before processing is 0.7, the signal value after processing is 0.8. The minimum signal value Black remains at zero before and after the processing. In the example shown in FIG. 19, the larger the signal value before processing is, the larger the signal value after processing is until the signal value after processing becomes 1.0.

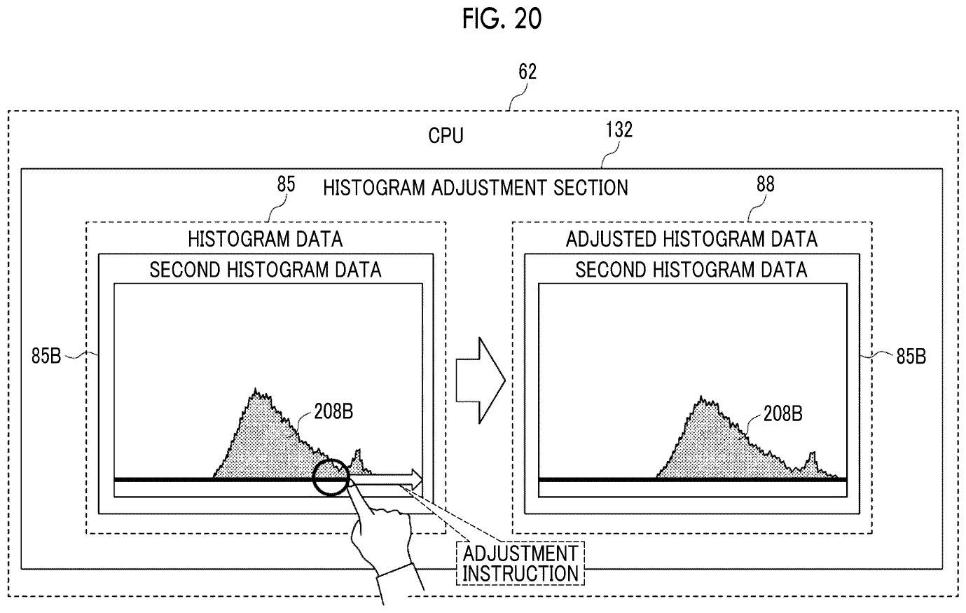

As an example, FIG. 20 shows a state where the adjusted histogram data 88 is generated by the histogram adjustment section 132 in accordance with the plus-side swipe instruction. As shown in FIG. 20 as an example, the form of the second histogram 208B is changed in accordance with the plus-side swipe instruction. Specifically, due to the plus-side swipe instruction, the shape of the second histogram 208B is changed to a higher signal value than that before the plus-side swipe instruction is received by the reception device 76. The adjusted histogram data 88 generated by the histogram adjustment section 132 includes the second histogram data 85B indicating the second histogram 208B in which the content of the plus-side swipe instruction is reflected. According to the adjusted histogram data 88 shown in FIG. 20 as an example, the brightness of the second region 206B (see FIG. 17) becomes brighter than that of the histogram data 85.

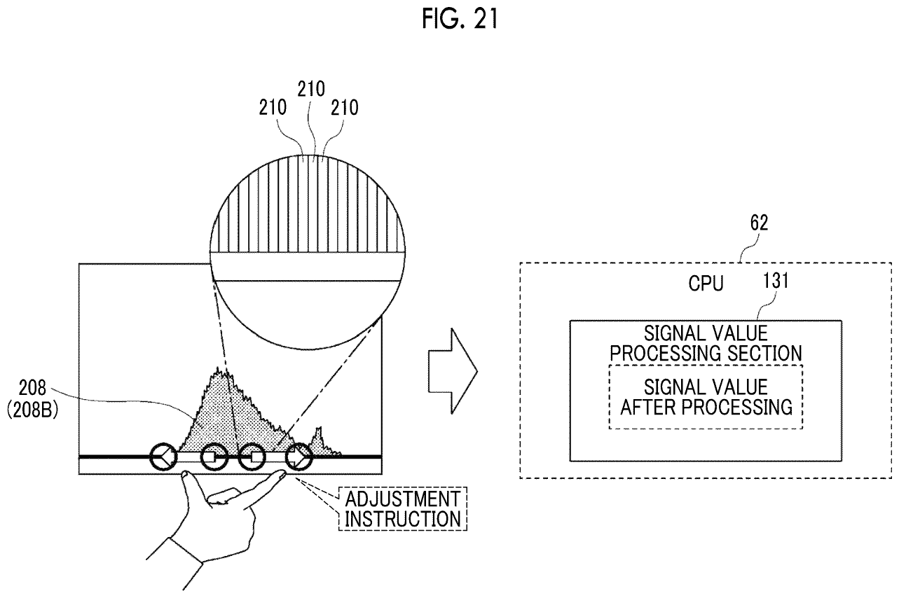

In addition, as shown in FIG. 21 as an example, the adjustment instruction may be an instruction to move the bin 210 in a direction in which a difference between two signal values selected based on the adjustment instruction becomes larger than that before the adjustment instruction is received by the reception device 76. Further, the adjustment instruction may be an instruction to move the bin 210 by performing a pinch-out on the touch panel 30 (see FIG. 12). Hereinafter, in a case where it is necessary to distinguish the adjustment instruction of the aspect shown in FIG. 21 from the adjustment instruction of the other aspect for description, the adjustment instruction of the aspect shown in FIG. 21 is referred to as a pinch-out instruction. In a case where the adjustment instruction is the pinch-out instruction, the signal value processing section 131 calculates the signal value corresponding to each image pixel by using Equations (5), (6), and (7). Note that Equation (6) is applied to a case where Value₁<Black, and Equation (7) is applied to a case where Value₁>White.

$${Value}_{1} = a \times {Value}_{0} + b \qquad ( 5 )$$

$${Value}_{1} = Black \qquad ( 6 )$$

$${Value}_{1} = White \qquad ( 7 )$$

a is a slope. b is an intercept. The slope a and the intercept b are obtained by following equations. Sel₀ is a value before processing of a smaller signal value (hereinafter, referred to as a first signal value) of two signal values selected based on the adjustment instruction. Sel₁ is a value after processing of the first signal value selected based on the adjustment instruction. Sel₂ is a value before processing of a larger signal value (hereinafter, referred to as a second signal value) of two signal values selected based on the adjustment instruction. Sel₃ is a value after processing of the second signal value selected based on the adjustment instruction. Note that Sel₁≤Sel₀≤Sel₂≤Sel₃.

In a case where Value₀≤Sel₀, the slope a is calculated by Equation (8), and the intercept b is calculated by Equation (9).

$$a = \frac{( {Sel}_{1} - Black )}{( {Sel}_{0} - Black )} \qquad ( 8 )$$

$$b = {Sel}_{1} - a \times {Sel}_{0} \qquad ( 9 )$$

In a case where Sel₀<Value₀≤Sel₃, the slope a is calculated by Equation (10), and the intercept b is calculated by Equation (11).

$$a = \frac{( {Sel}_{3} - {Sel}_{1} )}{( {Sel}_{2} - {Sel}_{0} )} \qquad ( 10 )$$

$$b = {Sel}_{1} - a \times {Sel}_{0} \qquad ( 11 )$$

In a case where Sel₃<Value₀, the slope a is calculated by Equation (12), and the intercept b is calculated by Equation (13).

$$a = \frac{( White - {Sel}_{3} )}{( White - {Sel}_{2} )} \qquad ( 12 )$$

$$b = {Sel}_{3} - a \times {Sel}_{2} \qquad ( 13 )$$

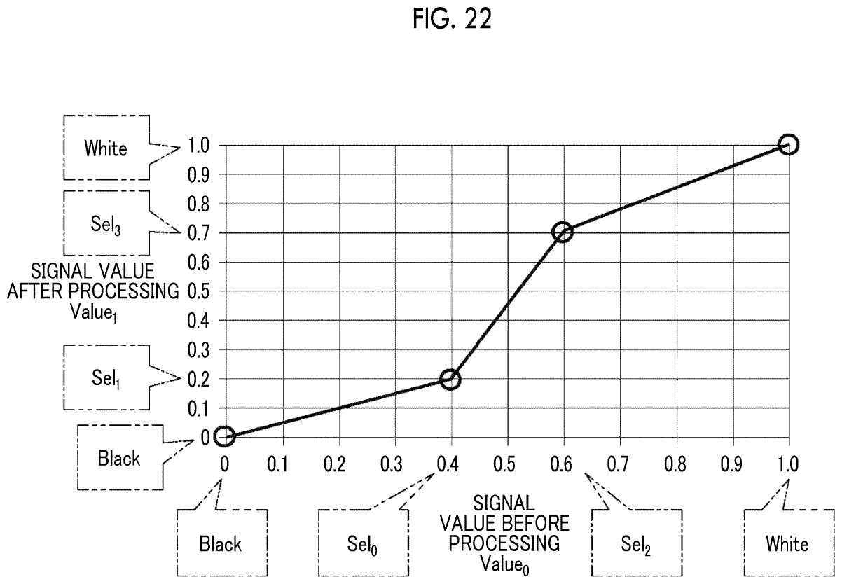

As an example, FIG. 22 shows a graph showing a relationship between a signal value before processing and a signal value after processing in a case where the pinch-out instruction is received by the reception device 76. In the example shown in FIG. 22, the value Sel₀ before processing of the first signal value selected based on the pinch-out instruction is 0.4, and the value Sel₁ after processing of the first signal value selected based on the pinch-out instruction is 0.2. The value Sel₂ before processing of the second signal value selected based on the pinch-out instruction is 0.6, and the value Sel₃ after processing of the second signal value selected based on the pinch-out instruction is 0.7. The minimum signal value Black is 0, and the maximum signal value White is 1.0. In a case where the signal value before processing is 0.4, the signal value after processing is 0.2. In a case where the signal value before processing is 0.6, the signal value after processing is 0.7. The minimum signal value Black remains at zero before and after the processing. The range of the signal value before processing, 0.4 to 0.6, changes to 0.2 to 0.7 after the processing.

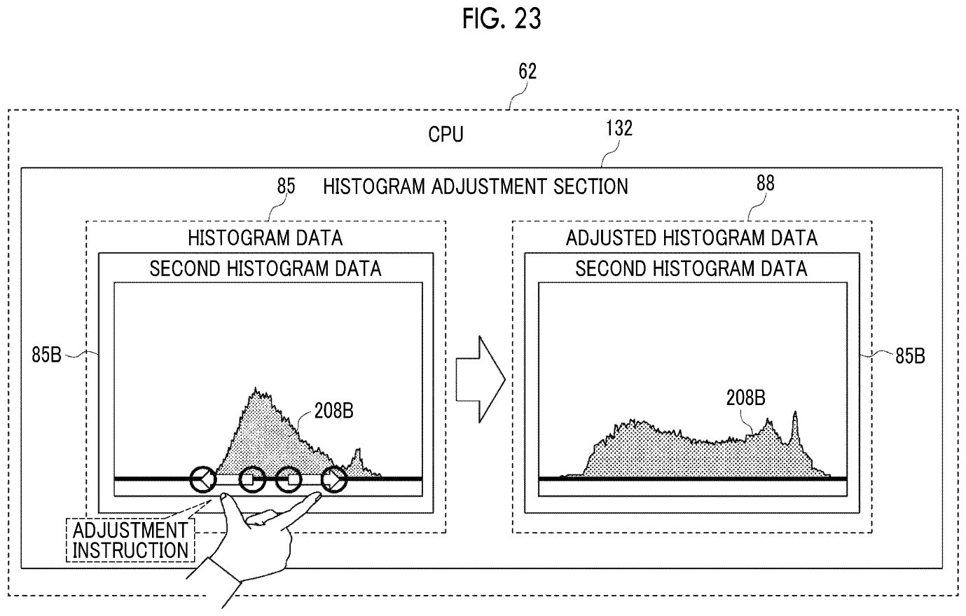

As an example, FIG. 23 shows a state where the adjusted histogram data 88 is generated by the histogram adjustment section 132 in accordance with the pinch-out instruction. As shown in FIG. 23 as an example, the form of the second histogram 208B is changed in accordance with the pinch-out instruction. Specifically, due to the pinch-out instruction, the shape of the second histogram 208B expands as compared with that before the pinch-out instruction is received by the reception device 76. The adjusted histogram data 88 generated by the histogram adjustment section 132 includes the second histogram data 85B indicating the second histogram 208B in which the content of the pinch-out instruction is reflected. According to the adjusted histogram data 88 shown in FIG. 23 as an example, the contrast of the second region 206B (see FIG. 17) is enhanced as compared with that of the histogram data 85.

Although an example in which the pinch-out instruction is received by the reception device 76 is shown in FIGS. 21 to 23, the adjustment instruction may be an instruction to move the bin 210 by performing a pinch-in on the touch panel (that is, a pinch-in instruction). In this case, the contrast of the region 206 corresponding to the adjustment instruction is weakened as compared with that before the pinch-in instruction is received by the reception device 76.

In addition, the minus-side swipe instruction shown in FIGS. 12 to 15 and the plus-side swipe instruction shown in FIGS. 18 to 20 may be sequentially received by the reception device 76. Further, the minus-side swipe instruction shown in FIGS. 12 to 15 and the plus-side swipe instruction shown in FIGS. 18 to 20 may be received by the reception device 76 as one adjustment instruction. In this case, processing of calculating the signal value after processing corresponding to the minus-side swipe instruction and processing of calculating the signal value after processing corresponding to the plus-side swipe instruction are sequentially performed.

Further, the adjustment instruction may be an instruction to slide the entire histogram 208 (that is, a slide instruction). In this case, the brightness of the entirety of the region 206 corresponding to the adjustment instruction is changed. Moreover, the adjustment instruction is received by the touch panel 30, but may be received by the hard key unit 78 or may be received by an external device (not shown) connected to the external I/F 50.

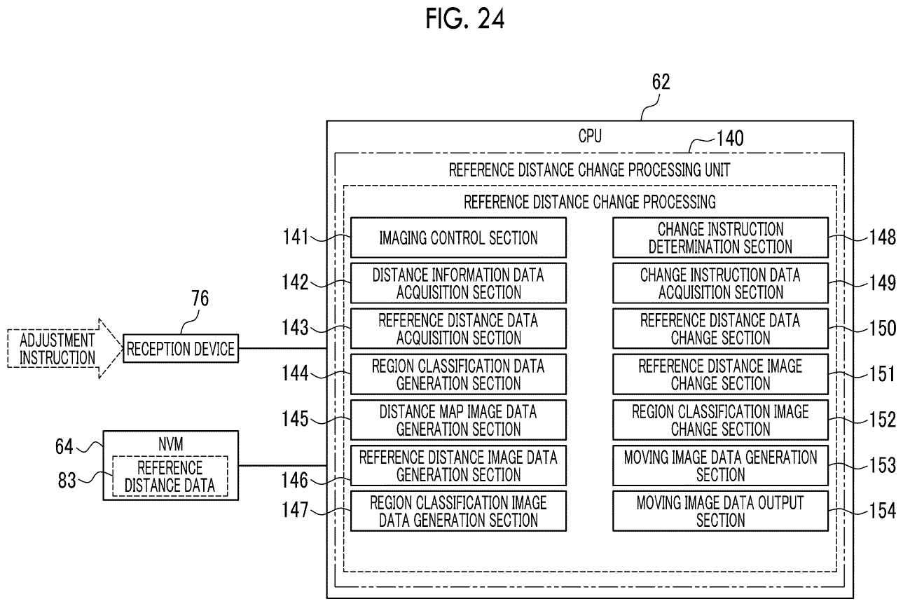

As shown in FIG. 24 as an example, the reference distance change processing unit 140 performs reference distance change processing for changing the reference distance data 83 based on a change instruction received by the reception device 76. The reference distance change processing unit 140 has an imaging control section 141, a distance information data acquisition section 142, a reference distance data acquisition section 143, a region classification data generation section 144, a distance map image data generation section 145, a reference distance image data generation section 146, a region classification image data generation section 147, a change instruction determination section 148, a change instruction data acquisition section 149, a reference distance data change section 150, a reference distance image change section 151, a region classification image change section 152, a moving image data generation section 153, and a moving image data output section 154.

The imaging control section 141, the distance information data acquisition section 142, and the reference distance data acquisition section 143 are the same as the second imaging control section 123, the distance information data acquisition section 124, and the reference distance data acquisition section 125 (hereinabove, see FIG. 8) in the image adjustment processing unit 120. In addition, the region classification data generation section 144 is the same as the region classification data generation section 126 (see FIG. 9) in the image adjustment processing unit 120.

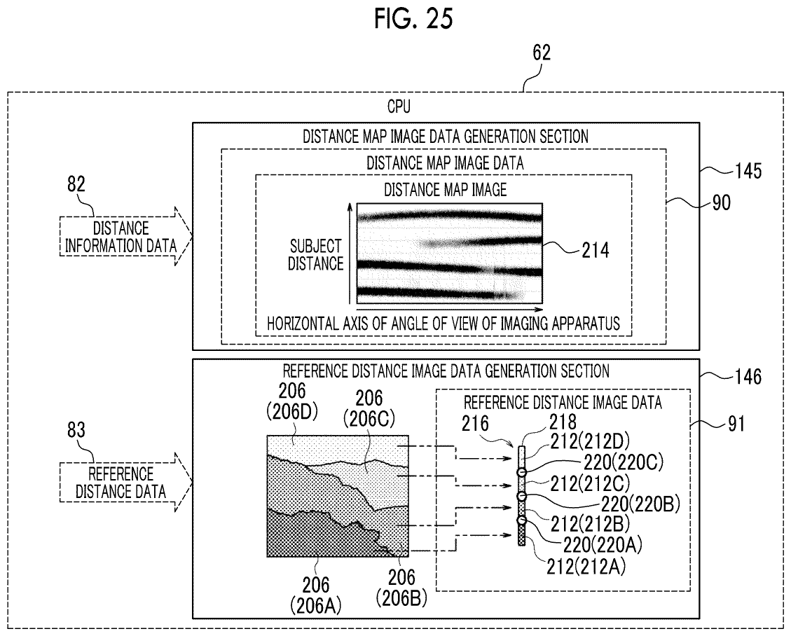

As shown in FIG. 25 as an example, the distance map image data generation section 145 generates distance map image data 90 indicating a distance map image 214 based on the distance information data 82. The distance map image 214 is an image representing a distribution of the subject distances with respect to an angle of view of the imaging apparatus 10. In other words, the horizontal axis of a distance map indicated by the distance map image 214 indicates the horizontal axis of the angle of view of the imaging apparatus 10, and the vertical axis of the distance map indicated by the distance map image 214 indicates the subject distance. The distance map image 214 is an example of a “distance map image” according to the technology of the present disclosure. The distance map image data 90 is an example of “third image data” according to the technology of the present disclosure.

The reference distance image data generation section 146 generates reference distance image data 91 indicating a reference distance image 216 based on the reference distance data 83. The reference distance image 216 is an image representing a plurality of reference distances for classifying the plurality of regions 206. The reference distance image 216 is an example of a “reference distance image” according to the technology of the present disclosure. The reference distance image data 91 is an example of “fourth image data” according to the technology of the present disclosure.

As an example, the reference distance image 216 is an image showing a scale bar 218 and a plurality of sliders 220. The scale bar 218 indicates the plurality of distance ranges 212 corresponding to the plurality of regions 206. Specifically, the scale bar 218 indicates the first distance range 212A corresponding to the first region 206A, the second distance range 212B corresponding to the second region 206B, the third distance range 212C corresponding to the third region 206C, and the fourth distance range 212D corresponding to the fourth region 206D. The scale bar 218 is one scale bar collectively indicating the plurality of distance ranges 212.

The plurality of sliders 220 are provided on the scale bar 218. The position of each slider 220 indicates the reference distance. Hereinafter, in a case where it is necessary to distinguish between the plurality of reference distances for description, the reference distance for classifying the first region 206A and the second region 206B is referred to as the first reference distance, the reference distance for classifying the second region 206B and the third region 206C is referred to as the second reference distance, and the reference distance for classifying the third region 206C and the fourth region 206D is referred to as the third reference distance.

Hereinafter, in a case where it is necessary to distinguish between the plurality of sliders 220, the slider 220 corresponding to the first reference distance is referred to as a first slider 220A, the slider 220 corresponding to the second reference distance is referred to as a second slider 220B, and the slider 220 corresponding to the third reference distance is referred to as a third slider 220C. The first slider 220A indicates the first reference distance that defines a boundary between the first distance range 212A and the second distance range 212B. The second slider 220B indicates the second reference distance that defines a boundary between the second distance range 212B and the third distance range 212C. The third slider 220C indicates the third reference distance that defines a boundary between the third distance range 212C and the fourth distance range 212D.

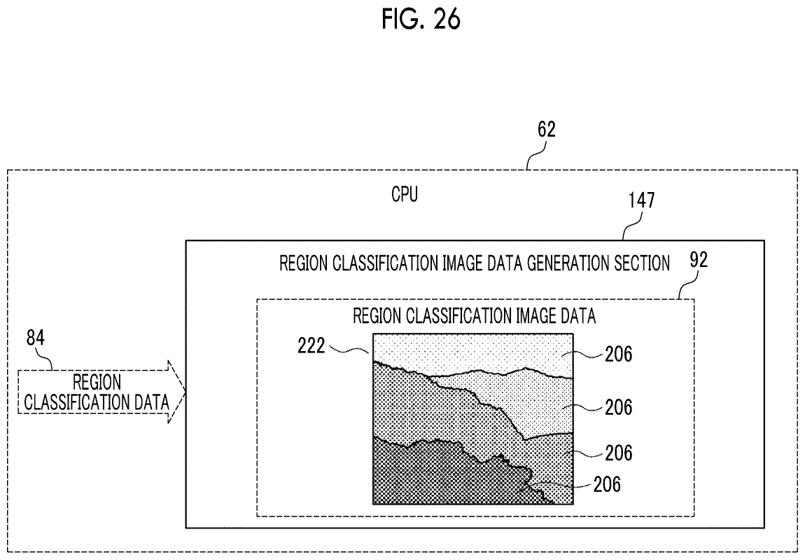

As shown in FIG. 26 as an example, the region classification image data generation section 147 generates region classification image data 92 indicating a region classification image 222 based on the region classification data 84. The region classification image 222 is an image in which the plurality of regions 206 are divided in different aspects according to the subject distances. Examples of the different aspects include different colors, dots with different densities, and hatching in different forms. The region classification image 222 is an example of a “second image” and a “third image” according to the technology of the present disclosure. The region classification image data 92 is an example of “second image data” according to the technology of the present disclosure.

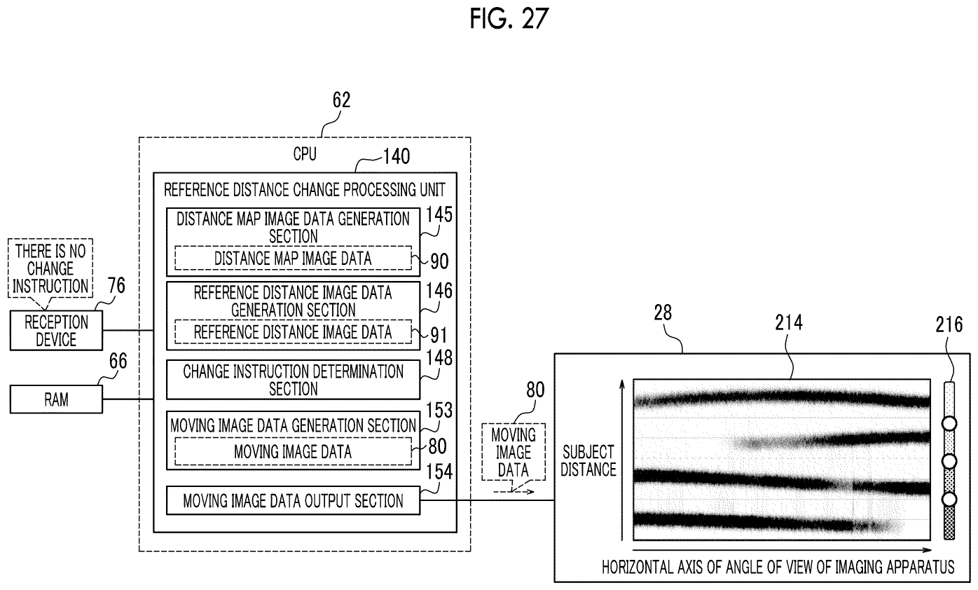

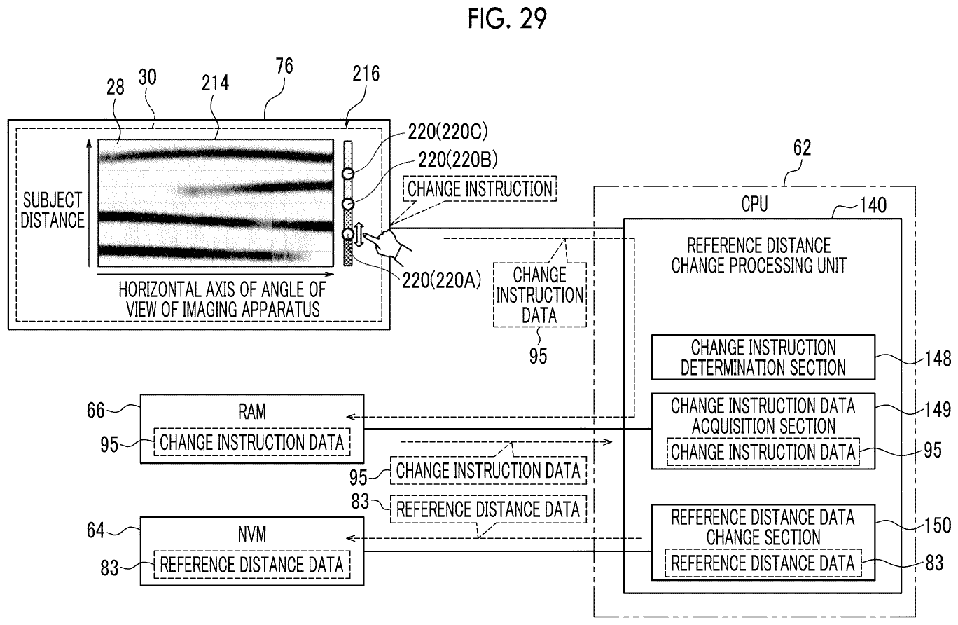

As an example, FIG. 27 shows an example of a case where no change instruction is received by the reception device 76. The change instruction is an instruction to change any reference distance among the plurality of reference distances. In a case where the change instruction is received by the reception device 76, change instruction data 95 (see FIG. 29) is stored in the RAM 66, but in a case where no change instruction is received by the reception device 76, the change instruction data 95 is not stored in the RAM 66. The change instruction determination section 148 determines whether or not the change instruction data 95 is stored in the RAM 66.

In a case where the change instruction determination section 148 determines that the change instruction data 95 indicating the change instruction is not stored in the RAM 66, the moving image data generation section 153 generates the moving image data 80 including the distance map image data 90 acquired by the distance map image data generation section 145 and the reference distance image data 91 generated by the reference distance image data generation section 146.

The moving image data output section 154 outputs the moving image data 80 generated by the moving image data generation section 153 to the display 28. The display 28 displays an image based on the moving image data 80. In the example shown in FIG. 27, the distance map image 214 indicated by the distance map image data 90 and the reference distance image 216 indicated by the reference distance image data 91 are displayed on the display 28.

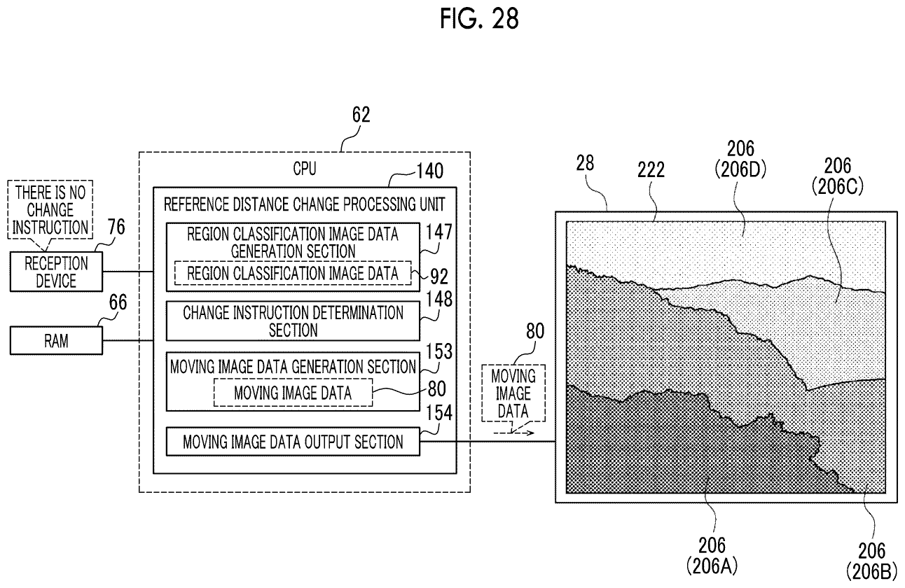

Further, as shown in FIG. 28 as an example, in a case where the change instruction determination section 148 determines that the adjustment instruction data 86 indicating the change instruction is not stored in the RAM 66, the moving image data generation section 153 generates the moving image data 80 including the region classification image data 92 generated by the region classification image data generation section 147.

The moving image data output section 154 outputs the moving image data 80 generated by the moving image data generation section 153 to the display 28. The display 28 displays an image based on the moving image data 80. In the example shown in FIG. 28, the region classification image 222 indicated by the region classification image data 92 is displayed on the display 28.

The region classification image 222 may be displayed on the display 28 together with the distance map image 214 and the reference distance image 216 or may be displayed on the display 28 while being switched with the distance map image 214 and the reference distance image 216.

As an example, FIG. 29 shows an example of a case where the change instruction is received by the reception device 76. The change instruction is an instruction to slide at least one slider 220 of the plurality of sliders 220. As an example, the change instruction is an instruction to change the position of the slider 220 displayed on the display 28 through the touch panel 30. As an example, FIG. 29 shows an example in which the change instruction is an instruction to slide the first slider 220A. The change instruction is received by the touch panel 30, but may be received by the hard key unit 78 or may be received by an external device (not shown) connected to the external I/F 50.

In a case where the change instruction is received by the reception device 76, the reference distance change processing unit 140 stores the change instruction data 95 indicating the change instruction in the RAM 66. Specifically, data indicating the slider 220 selected based on the change instruction and a slide amount of the slider 220 is stored in the RAM 66 as the change instruction data 95.

In a case where the change instruction determination section 148 determines that the change instruction data 95 indicating the change instruction is stored in the RAM 66, the change instruction data acquisition section 149 acquires the change instruction data 95 stored in the RAM 66. The reference distance data change section 150 changes the reference distance data 83 in accordance with the change instruction data 95. As a result, the reference distance is changed in accordance with the change instruction. The reference distance data change section 150 rewrites the reference distance data 83 stored in the NVM 64 based on the changed reference distance data 83. As a result, the reference distance data 83 stored in the NVM 64 is updated.

The change instruction is an example of a “second instruction” and a “third instruction” according to the technology of the present disclosure.

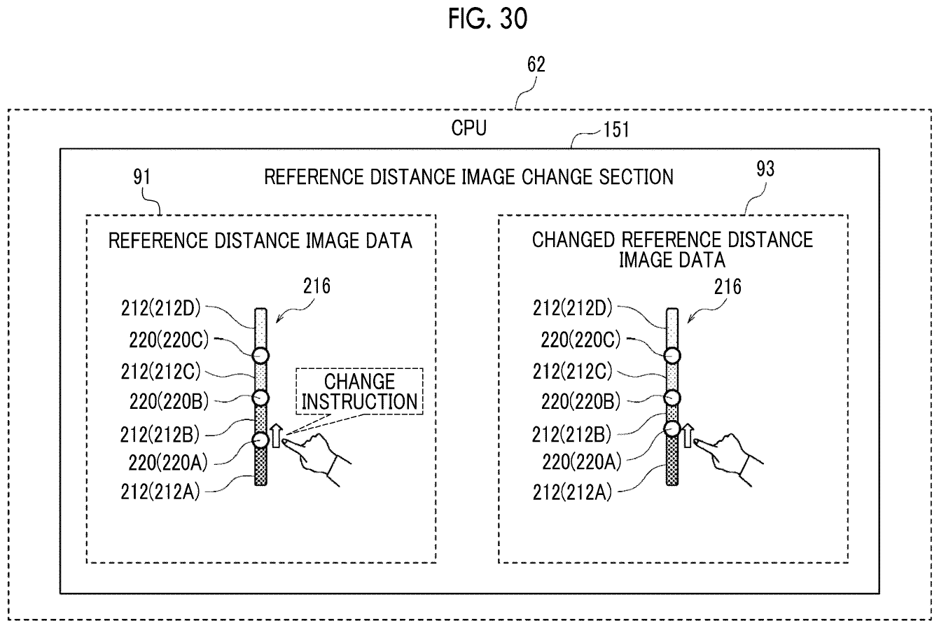

As shown in FIG. 30 as an example, the reference distance image change section 151 performs processing of reflecting the content of the change instruction in the reference distance image 216. Specifically, changed reference distance image data 93 in which the content of the change instruction is reflected in the reference distance image 216 is generated. The changed reference distance image data 93 is data indicating the reference distance image 216 in which the reference distance is changed in accordance with the change instruction. As an example, FIG. 30 shows an example in which the change instruction is an instruction to slide the first slider 220A to a second distance range 212B side. By sliding the first slider 220A to the second distance range 212B side, the first reference distance is changed. The processing of reflecting the content of the change instruction in the reference distance image 216 is an example of “fourth processing” according to the technology of the present disclosure.

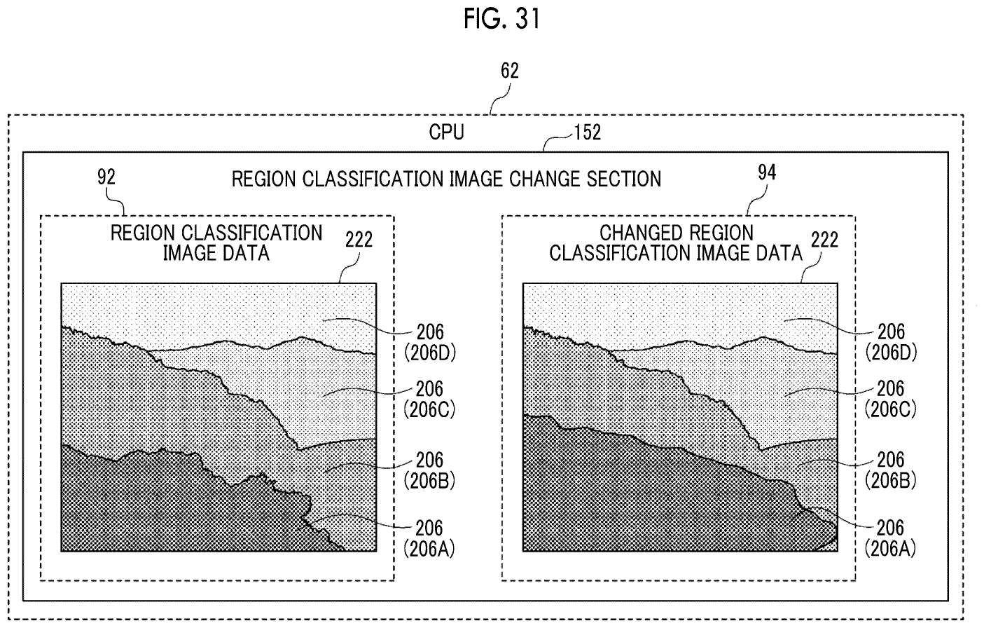

As shown in FIG. 31 as an example, the region classification image change section 152 performs processing of reflecting the content of the change instruction in the region classification image 222. Specifically, changed region classification image data 94 in which the content of the change instruction is reflected in the region classification image 222 is generated. The changed region classification image data 94 is data indicating the region classification image 222 in which the areas of the adjacent regions among the plurality of regions 206 are changed in accordance with the change instruction. As an example, FIG. 31 shows a state where the first region 206A expands as compared with that before the change instruction is received by the reception device 76, in response to the change instruction, which is an instruction to slide the first slider 220A to the second distance range 212B side (see FIG. 30). The changed region classification image data 94 is an example of “fifth image data” according to the technology of the present disclosure. The processing of reflecting the content of the change instruction in the region classification image 222 is an example of “fourth processing” according to the technology of the present disclosure.

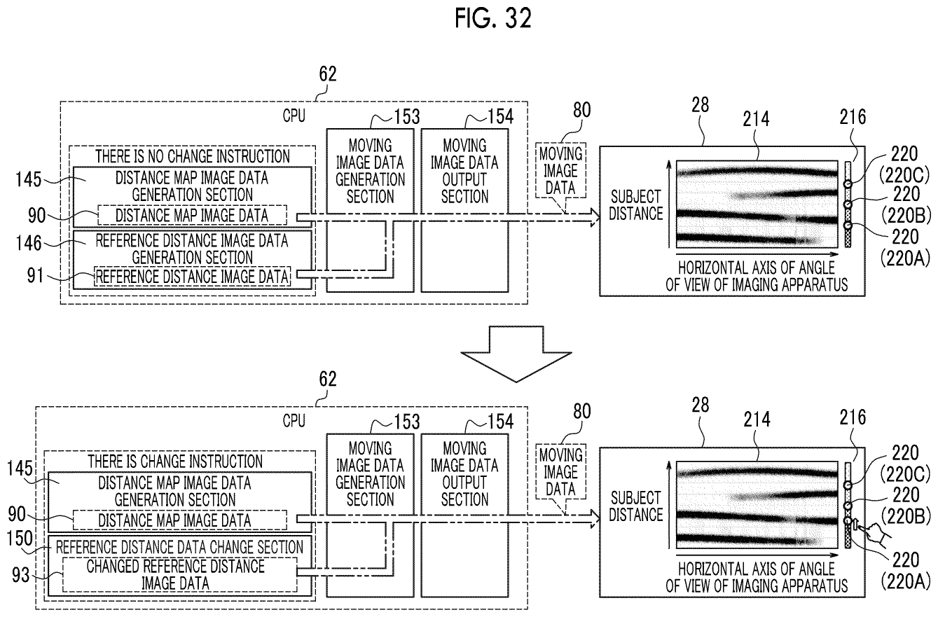

As an example, FIG. 32 shows a state where the reference distance image 216 changes in a case where a state before the change instruction is received by the reception device 76 transitions to a state after the change instruction is received by the reception device 76.

As shown in FIG. 32 as an example, the moving image data generation section 153 generates the moving image data 80 including the distance map image data 90 and the reference distance image data 91 in a case where no change instruction is received by the reception device 76, but generates the moving image data 80 including the distance map image data 90 and the changed reference distance image data 93 in a case where the change instruction is received by the reception device 76.

The moving image data output section 154 outputs the moving image data 80 generated by the moving image data generation section 153 to the display 28. The display 28 displays an image based on the moving image data 80. In the example shown in FIG. 32, the position of the first slider 220A is changed based on the change instruction.

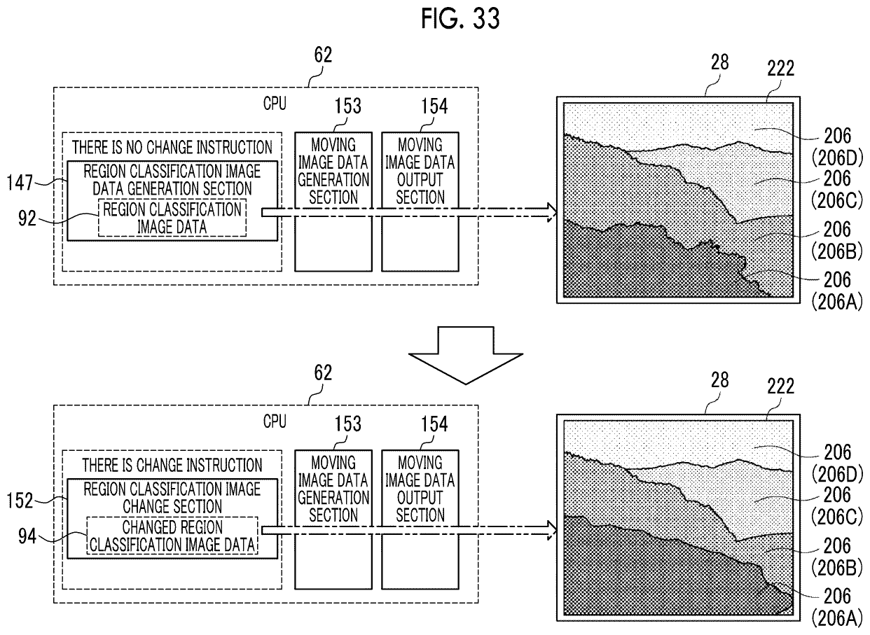

As an example, FIG. 33 shows a state where the region classification image 222 changes in a case where a state before the change instruction is received by the reception device 76 transitions to a state after the change instruction is received by the reception device 76.

The moving image data generation section 153 generates the moving image data 80 including the region classification image data 92 in a case where no change instruction is received by the reception device 76, but generates the moving image data 80 including the changed region classification image data 94 in a case where the change instruction is received by the reception device 76.

The moving image data output section 154 outputs the moving image data 80 generated by the moving image data generation section 153 to the display 28. The display 28 displays an image based on the moving image data 80. In the example shown in FIG. 33, the first region 206A expands as compared with that before the change instruction is received by the reception device 76.

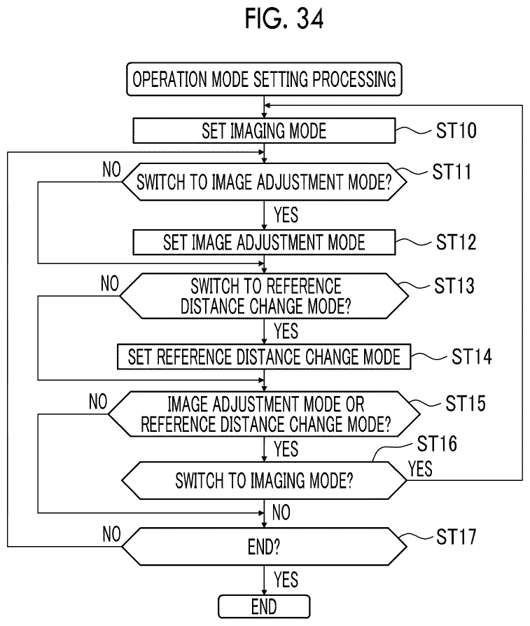

Next, the operation of the imaging apparatus 10 according to the present embodiment will be described with reference to FIGS. 34 to 36.

First, an example of a flow of the operation mode setting processing performed by the CPU 62 will be described with reference to FIG. 34.

In the operation mode setting processing shown in FIG. 34, first, in step ST10, the imaging mode setting section 101 sets the imaging mode as the initial setting of the operation mode of the imaging apparatus 10. After the processing of step ST10 is executed, the operation mode setting processing transitions to step ST11.

In step ST11, the first mode switching determination section 102 determines whether or not the first mode switching condition for switching the operation mode of the imaging apparatus 10 from the imaging mode to the image adjustment mode is established. As an example of the first mode switching condition, for example, a condition that the first mode switching instruction for switching the operation mode of the imaging apparatus 10 from the imaging mode to the image adjustment mode is received by the reception device 76, or the like is included. In step ST11, the determination is positive in a case where the first mode switching condition is established, and the operation mode setting processing transitions to step ST12. In step ST11, the determination is negative in a case where the first mode switching condition is not established, and the operation mode setting processing transitions to step ST13.

In step ST12, the image adjustment mode setting section 103 sets the image adjustment mode as the operation mode of the imaging apparatus 10. After the processing of step ST12 is executed, the operation mode setting processing transitions to step ST13.

In step ST13, the second mode switching determination section 104 determines whether or not the second mode switching condition for switching the operation mode of the imaging apparatus 10 from the imaging mode or the image adjustment mode to the reference distance change mode is established. As an example of the second mode switching condition, for example, a condition that the second mode switching instruction for switching the operation mode of the imaging apparatus 10 from the imaging mode or the image adjustment mode to the reference distance change mode is received by the reception device 76, or the like is included. In step ST13, the determination is positive in a case where the second mode switching condition is established, and the operation mode setting processing transitions to step ST14. In step ST13, the determination is negative in a case where the second mode switching condition is not established, and the operation mode setting processing transitions to step ST15.

In step ST14, the reference distance change mode setting section 105 sets the reference distance change mode as the operation mode of the imaging apparatus 10. After the processing of step ST14 is executed, the operation mode setting processing transitions to step ST15.

In step ST15, the third mode switching determination section 106 determines whether or not the operation mode of the imaging apparatus 10 is the image adjustment mode or the reference distance change mode. In step ST15, the determination is positive in a case where the operation mode of the imaging apparatus 10 is the image adjustment mode or the reference distance change mode, and the operation mode setting processing transitions to step ST16. In step ST15, the determination is negative in a case where the operation mode of the imaging apparatus 10 is not the image adjustment mode or the reference distance change mode, and the operation mode setting processing transitions to step ST17.

In step ST16, the third mode switching determination section 106 determines whether or not the third mode switching condition for switching the operation mode of the imaging apparatus 10 from the image adjustment mode or the reference distance change mode to the imaging mode is established. As an example of the third mode switching condition, for example, a condition that the third mode switching instruction for switching the operation mode of the imaging apparatus 10 from the image adjustment mode or the reference distance change mode to the imaging mode is received by the reception device 76, or the like is included. In step ST16, the determination is positive in a case where the third mode switching condition is established, and the operation mode setting processing transitions to step ST10. In step ST16, the determination is negative in a case where the third mode switching condition is not established, and the operation mode setting processing transitions to step ST17.

In step ST17, the CPU 62 determines whether or not a condition for ending the operation mode setting processing is established. An example of the condition for ending the operation mode setting processing includes a condition that an end instruction which is an instruction to end the operation mode setting processing (for example, an instruction to stop the power of the imaging apparatus 10) is received by the reception device 76. In step ST17, the determination is negative in a case where the condition for ending the operation mode setting processing is not established, and the operation mode setting processing transitions to step ST11. In step ST17, the determination is positive in a case where the condition for ending the operation mode setting processing is established, and the operation mode setting processing ends.

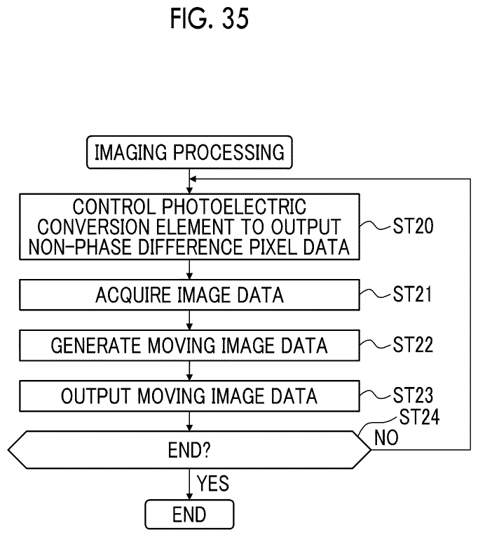

Next, an example of a flow of the imaging processing performed by the CPU 62 will be described with reference to FIG. 35.

In the imaging processing shown in FIG. 35, first, in step ST20, the imaging control section 111 controls the photoelectric conversion element 72 to output the non-phase difference pixel data 73A. After the processing of step ST20 is executed, the imaging processing transitions to step ST21.

In step ST21, the image data acquisition section 112 acquires the image data 81 generated by the signal processing circuit 74 through the digitizing of the non-phase difference pixel data 73A. After the processing of step ST21 is executed, the imaging processing transitions to step ST22.

In step ST22, the moving image data generation section 113 generates the moving image data 80 based on the image data 81 acquired by the image data acquisition section 112. After the processing of step ST22 is executed, the imaging processing transitions to step ST23.

In step ST23, the moving image data output section 114 outputs the moving image data 80 generated by the moving image data generation section 113 to the display 28. After the processing of step ST23 is executed, the imaging processing transitions to step ST24.

In step ST24, the CPU 62 determines whether or not a condition for ending the imaging processing is established. An example of the condition for ending the imaging processing includes a condition that the first mode switching instruction or the second mode switching instruction is received by the reception device 76. In step ST24, the determination is negative in a case where the condition for ending the imaging processing is not established, and the imaging processing transitions to step ST20. In step ST24, the determination is positive in a case where the condition for ending the imaging processing is established, and the imaging processing ends.

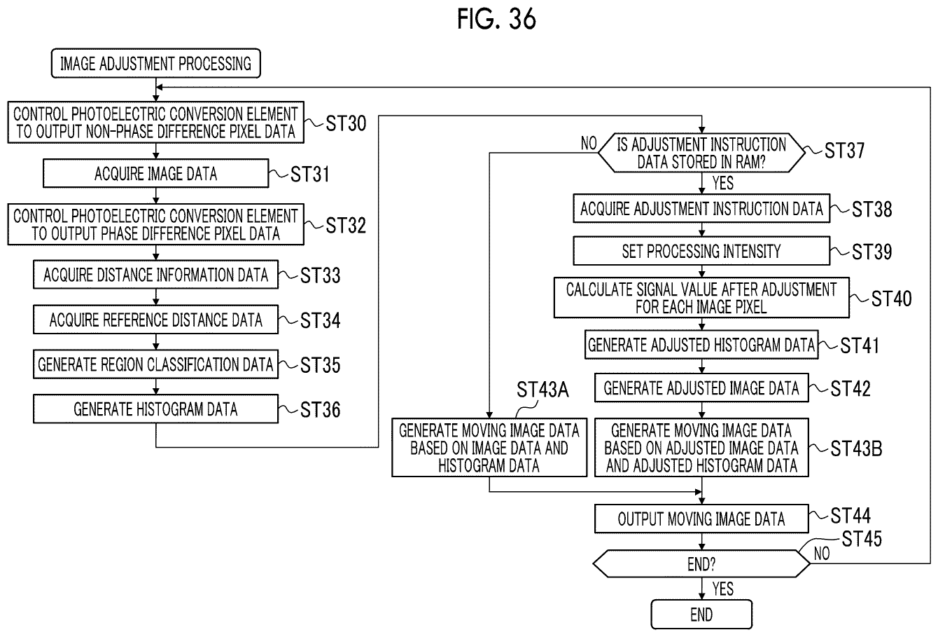

Next, an example of a flow of the image adjustment processing performed by the CPU 62 will be described with reference to FIG. 36.

In the image adjustment processing shown in FIG. 36, first, in step ST30, the first imaging control section 121 controls the photoelectric conversion element 72 to output the non-phase difference pixel data 73A. After the processing of step ST30 is executed, the image adjustment processing transitions to step ST31.

In step ST31, the image data acquisition section 122 acquires the image data 81 generated by the signal processing circuit 74 through the digitizing of the non-phase difference pixel data 73A. After the processing of step ST31 is executed, the image adjustment processing transitions to step ST32.

In step ST32, the second imaging control section 123 controls the photoelectric conversion element 72 to output the phase difference pixel data 73B. After the processing of step ST32 is executed, the image adjustment processing transitions to step ST33.

In step ST33, the distance information data acquisition section 124 acquires the distance information data 82 based on the phase difference pixel data 73B acquired from the signal processing circuit 74. After the processing of step ST33 is executed, the image adjustment processing transitions to step ST34.

In step ST34, the reference distance data acquisition section 125 acquires the reference distance data 83 stored in advance in the NVM 64. After the processing of step ST34 is executed, the image adjustment processing transitions to step ST35.

In step ST35, the region classification data generation section 126 generates the region classification data 84 for classifying the image 200 into the plurality of regions 206 according to the subject distances, based on the distance information data 82 and the reference distance data 83. After the processing of step ST35 is executed, the image adjustment processing transitions to step ST36.

In step ST36, the histogram data generation section 127 generates the histogram data 85 corresponding to each region 206 based on the image data 81 and the region classification data 84. After the processing of step ST36 is executed, the image adjustment processing transitions to step ST37.

In step ST37, the adjustment instruction determination section 128 determines whether or not the adjustment instruction data 86 is stored in the RAM 66. In step ST37, the determination is negative in a case where the adjustment instruction data 86 is not stored in the RAM 66, and the image adjustment processing transitions to step ST43A. In step ST37, the determination is positive in a case where the adjustment instruction data 86 is stored in the RAM 66, and the image adjustment processing transitions to step ST38.

In step ST38, the adjustment instruction data acquisition section 129 acquires the adjustment instruction data 86 stored in the RAM 66. After the processing of step ST38 is executed, the image adjustment processing transitions to step ST39.

In step ST39, the processing intensity setting section 130 sets the processing intensity corresponding to each image pixel based on the processing intensity data 87 stored in the NVM 64. After the processing of step ST39 is executed, the image adjustment processing transitions to step ST40.

In step ST40, the signal value processing section 131 calculates the signal value after adjustment for each image pixel based on the processing intensity set by the processing intensity setting section 130. After the processing of step ST40 is executed, the image adjustment processing transitions to step ST41.

In step ST41, the histogram adjustment section 132 generates the adjusted histogram data 88 in which the content of the adjustment instruction is reflected in at least one histogram 208 of the plurality of histograms 208, based on the signal value calculated by the signal value processing section 131. After the processing of step ST40 is executed, the image adjustment processing transitions to step ST42.

In step ST42, the image adjustment section 133 generates the adjusted image data 89 in which the content of the adjustment instruction is reflected in at least one region 206 of the plurality of regions 206, based on the signal value calculated by the signal value processing section 131. After the processing of step ST42 is executed, the image adjustment processing transitions to step ST43B.

In step ST43A, the moving image data generation section 134 generates the moving image data 80 including the image data 81 and the histogram data 85. After the processing of step ST43A is executed, the image adjustment processing transitions to step ST44.

In step ST43B, the moving image data generation section 134 generates the moving image data 80 including the adjusted image data 89 and the adjusted histogram data 88. After the processing of step ST43B is executed, the image adjustment processing transitions to step ST44.

In step ST44, the moving image data output section 135 outputs the moving image data 80 generated by the moving image data generation section 134 to the display 28. After the processing of step ST44 is executed, the image adjustment processing transitions to step ST45.

In step ST45, the CPU 62 determines whether or not a condition for ending the image adjustment processing is established. An example of the condition for ending the image adjustment processing includes a condition that the second mode switching instruction or the third mode switching instruction is received by the reception device 76. In step ST45, the determination is negative in a case where the condition for ending the image adjustment processing is not established, and the image adjustment processing transitions to step ST30. In step ST45, the determination is positive in a case where the condition for ending the image adjustment processing is established, and the image adjustment processing ends.

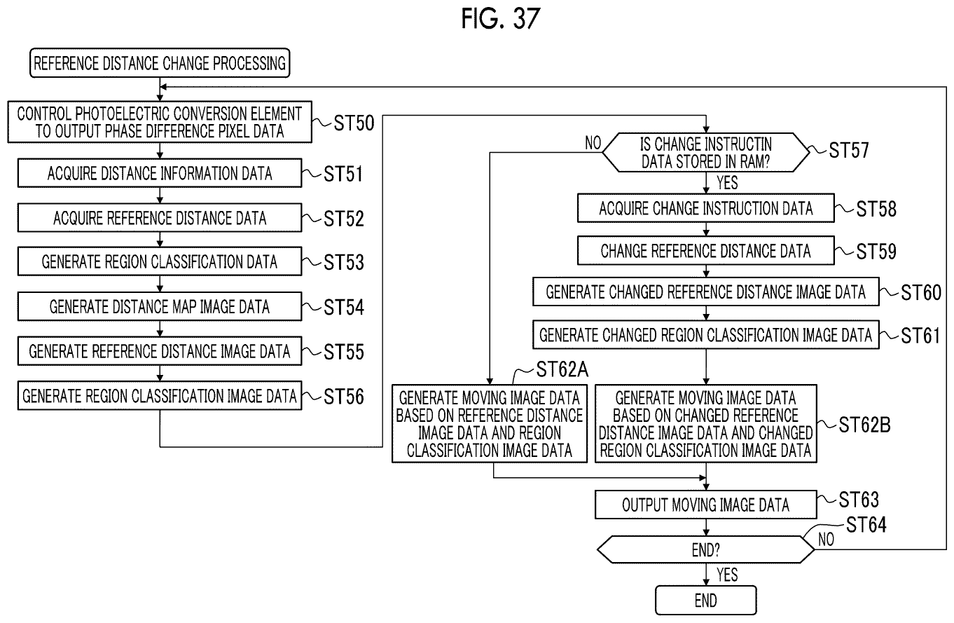

Next, an example of a flow of the reference distance change processing performed by the CPU 62 of the imaging apparatus 10 will be described with reference to FIG. 37.

In the reference distance change processing shown in FIG. 37, first, in step ST50, the imaging control section 141 controls the photoelectric conversion element 72 to output the phase difference pixel data 73B. After the processing of step ST50 is executed, the reference distance change processing transitions to step ST51.

In step ST51, the distance information data acquisition section 142 acquires the distance information data 82 based on the phase difference pixel data 73B acquired from the signal processing circuit 74. After the processing of step ST51 is executed, the reference distance change processing transitions to step ST52.

In step ST52, the reference distance data acquisition section 143 acquires the reference distance data 83 stored in advance in the NVM 64. After the processing of step ST52 is executed, the reference distance change processing transitions to step ST53.

In step ST53, the region classification data generation section 144 generates the region classification data 84 for classifying the image 200 into the plurality of regions 206 according to the subject distances, based on the distance information data 82 and the reference distance data 83. After the processing of step ST53 is executed, the reference distance change processing transitions to step ST54.

In step ST54, the distance map image data generation section 145 generates the distance map image data 90 indicating the distance map image 214 based on the distance information data 82. After the processing of step ST54 is executed, the reference distance change processing transitions to step ST55.

In step ST55, the reference distance image data generation section 146 generates the reference distance image data 91 indicating the reference distance image 216 based on the reference distance data 83. After the processing of step ST55 is executed, the reference distance change processing transitions to step ST56.

In step ST56, the region classification image data generation section 147 generates the region classification image data 92 indicating the region classification image 222 based on the region classification data 84. After the processing of step ST56 is executed, the reference distance change processing transitions to step ST57.

In step ST57, the change instruction determination section 148 determines whether or not the change instruction data 95 is stored in the RAM 66. In step ST57, the determination is negative in a case where the change instruction data 95 is not stored in the RAM 66, and the reference distance change processing transitions to step ST62A. In step ST57, the determination is positive in a case where the change instruction data 95 is stored in the RAM 66, and the reference distance change processing transitions to step ST58.

In step ST58, the change instruction data acquisition section 149 acquires the change instruction data 95 stored in the RAM 66. After the processing of step ST58 is executed, the reference distance change processing transitions to step ST59.

In step ST59, the reference distance data change section 150 changes the reference distance data 83 in accordance with the change instruction data 95. After the processing of step ST59 is executed, the reference distance change processing transitions to step ST60.

In step ST60, the reference distance image change section 151 generates the changed reference distance image data 93 in which the content of the change instruction is reflected in the reference distance image 216. After the processing of step ST60 is executed, the reference distance change processing transitions to step ST61.

In step ST61, the region classification image change section 152 generates the changed region classification image data 94 in which the content of the change instruction is reflected in the region classification image 222. After the processing of step ST61 is executed, the reference distance change processing transitions to step ST62B.

In step ST62A, the moving image data generation section 153 generates the moving image data 80 including the reference distance image data 91 and the region classification image data 92. After the processing of step ST62A is executed, the reference distance change processing transitions to step ST63.

In step ST62B, the moving image data generation section 153 generates the moving image data 80 including the changed reference distance image data 93 and the changed region classification image data 94. After the processing of step ST62B is executed, the reference distance change processing transitions to step ST63.

In step ST63, the moving image data output section 154 outputs the moving image data 80 generated by the moving image data generation section 153 to the display 28. After the processing of step ST63 is executed, the reference distance change processing transitions to step ST64.

In step ST64, the CPU 62 determines whether or not a condition for ending the reference distance change processing is established. An example of the condition for ending the reference distance change processing includes a condition that the first mode switching instruction or the third mode switching instruction is received by the reception device 76. In step ST64, the determination is negative in a case where the condition for ending the reference distance change processing is not established, and the reference distance change processing transitions to step ST50. In step ST64, the determination is positive in a case where the condition for ending the reference distance change processing is established, and the reference distance change processing ends.

The control method described as the operation of the imaging apparatus 10 is an example of an “image processing method” according to the technology of the present disclosure.

As described above, in the imaging apparatus 10 according to the present embodiment, the CPU 62 acquires the distance information data 82 related to the subject distance corresponding to each photosensitive pixel 72B. The CPU 62 outputs the image data 81 indicating the image 200 obtained by imaging with the image sensor 20. In addition, the CPU 62 classifies the image 200 into the plurality of regions 206 according to the distances based on the distance information data 82 and outputs the histogram data 85 indicating the histogram 208 created based on the signal of the image data 81 for at least one region 206 of the plurality of regions 206. Then, in a case where the adjustment instruction related to the histogram 208 is received by the reception device 76, the CPU 62 performs processing of reflecting the content of the adjustment instruction in the image 200 and the histogram 208. Therefore, the aspects of the image 200 and the histogram 208 can be changed according to the adjustment instruction received by the reception device 76. For example, the user can adjust the intensity of the mist 204 appearing as an image in the image 200 according to the user's intention.

Further, the CPU 62 outputs the histogram data 85 indicating the histogram 208. Therefore, the user can obtain the brightness information of the region 206 corresponding to the histogram 208 based on the histogram 208.

Further, the histogram 208 is the histogram 208 indicating the relationship between the signal value and the number of pixels. Therefore, the user can understand the relationship between the signal value and the number of pixels based on the histogram 208.

Further, the CPU 62 outputs the histogram data 85 indicating the histogram 208 created based on the signal value for each region 206. The processing of reflecting the content of the adjustment instruction in the histogram 208 includes the processing of prohibiting the content of the adjustment instruction from being reflected in the other histograms 208 different from the histogram 208 corresponding to the adjustment instruction. Therefore, it is possible to prevent the forms of the other histograms 208 different from the histogram 208 corresponding to the adjustment instruction from being changed. In addition, the processing of reflecting the content of the adjustment instruction in the image 200 includes the processing of prohibiting the content of the adjustment instruction from being reflected in the other regions 206 different from the region 206 corresponding to the adjustment instruction. Therefore, it is possible to prevent the forms of the other regions 206 different from the region 206 corresponding to the adjustment instruction from being changed.

Further, the processing of reflecting the content of the adjustment instruction in the image 200 and the histogram 208 is processing of changing the signal value according to the content of the adjustment instruction. Therefore, it is possible to change the aspects of the image 200 and the histogram 208 according to the content of the adjustment instruction received by the reception device 76.

Moreover, the adjustment instruction is an instruction to change the form of the histogram 208. Therefore, the user gives an instruction to change the form of the histogram 208 to the reception device 76 as the adjustment instruction, whereby it is possible to change the aspects of the image 200 and the histogram 208.

Further, the histogram 208 has the plurality of bins 210, and the adjustment instruction is an instruction to move the bin 210 corresponding to the signal value selected based on the adjustment instruction among the plurality of bins 210. Therefore, by moving the bin 210, the form of the histogram 208 can be changed.

Further, the CPU 62 outputs the region classification image data 92 indicating the region classification image 222 in which the plurality of regions 206 are divided in different aspects according to the subject distances. Therefore, the user can understand the plurality of regions 206 based on the region classification image 222.

Further, the CPU 62 outputs the distance map image data 90 showing the distance map image 214 representing the distribution of the subject distances with respect to the angle of view of the imaging apparatus 10. Therefore, the user can understand the distribution of the subject distances with respect to the angle of view of the imaging apparatus 10 based on the distance map image 214.

In addition, the CPU 62 outputs the reference distance image data 91 indicating the reference distance image 216 representing the reference distance for classifying the plurality of regions 206. Therefore, the user can understand the reference distance based on the reference distance image 216.

Further, the reference distance image 216 is an image showing the scale bar 218 and the slider 220. The scale bar 218 indicates the plurality of distance ranges 212 corresponding to the plurality of regions 206, and the slider 220 is provided on the scale bar 218. The position of the slider 220 indicates the reference distance. Therefore, the user can change the reference distance by changing the position of the slider 220. Further, the user can understand the reference distance based on the position of the slider 220.

Further, the scale bar 218 is one scale bar that collectively indicates the plurality of distance ranges 212. Therefore, the user can adjust the plurality of distance ranges 212 based on the one scale bar.

Further, in a case where the change instruction is received by the reception device 76, the CPU 62 outputs the region classification image data 92 indicating the region classification image 222. Therefore, the user can confirm the content of the change instruction based on the region classification image 222.

Further, in a case where the change instruction is received by the reception device 76, the CPU 62 performs processing of reflecting the content of the change instruction in the reference distance image 216. Therefore, the user can confirm the content of the change instruction based on the reference distance image 216.

Further, in a case where the change instruction is received by the reception device 76, the CPU 62 changes the reference distance according to the content of the change instruction. Therefore, it is possible to change the plurality of regions 206 classified based on the reference distance based on the change instruction.

Further, the image data 81 output by the CPU 62 is included in the moving image data 80. Therefore, it is possible to reflect the content of the adjustment instruction on the image 200 (that is, the moving image) displayed on the display 28 based on the moving image data 80.

Further, the imaging apparatus 10 comprises the image sensor 20 and the display 28. Therefore, the user can confirm the image 200 obtained by imaging with the image sensor 20 through the display 28.

Further, the CPU 62 outputs the image data 81 and the histogram data 85 to the display 28. Therefore, the image 200 and the histogram 208 can be displayed on the display 28.

Further, the CPU 62 performs processing of changing the display aspects of the image 200 and the histogram 208 displayed on the display 28. Therefore, the user can give the adjustment instruction to the reception device 76 while confirming the change of the display aspects of the image 200 and the histogram 208.

Further, the photoelectric conversion element 72 provided in the image sensor 20 has the plurality of photosensitive pixels 72B, and the CPU 62 acquires the distance information data 82 based on the phase difference pixel data 73B output from the photosensitive pixels 72B. Therefore, it is possible to eliminate the need for a distance sensor other than the image sensor 20.

Further, the photosensitive pixel 72B is a pixel that selectively outputs the non-phase difference pixel data 73A and the phase difference pixel data 73B. The non-phase difference pixel data 73A is pixel data obtained by performing photoelectric conversion on the entire region of the photosensitive pixel 72B, and the phase difference pixel data 73B is pixel data obtained by performing photoelectric conversion on a partial region of the photosensitive pixel 72B. Therefore, the image data 81 and the distance information data 82 can be acquired from the imaging data 73.

Although the CPU 62 reflects the content of the adjustment instruction in the image 200 and the histogram 208 in the above-described embodiment, the content of the adjustment instruction may be reflected in only one of the image 200 or the histogram 208.

In addition, the CPU 62 may perform processing of prohibiting the content of the adjustment instruction from being reflected in the region 206 other than the region 206 corresponding to the adjustment instruction, and may perform processing of reflecting the content of the adjustment instruction in the histogram 208 other than the histogram 208 corresponding to the adjustment instruction.

Further, the CPU 62 may perform processing of prohibiting the content of the adjustment instruction from being reflected in the histogram 208 other than the histogram 208 corresponding to the adjustment instruction, and may perform processing of reflecting the content of the adjustment instruction in the region 206 other than the region 206 corresponding to the adjustment instruction.

Moreover, the CPU 62 may output only one of the image data 81 or the histogram data 85 to the display 28.

Further, the CPU 62 may change the display aspect of only one of the image 200 or the histogram 208 displayed on the display 28, based on the adjustment instruction.

In addition, the CPU 62 outputs the moving image data 80 including the adjusted image data 89 and the adjusted histogram data 88 in the image adjustment processing, but may output still image data including the adjusted image data 89 and the adjusted histogram data 88.

Further, the CPU 62 outputs the moving image data 80 including the distance map image data 90 and the changed reference distance image data 93 in the reference distance change processing, but may output still image data including the distance map image data 90 and the changed reference distance image data 93.

Further, the imaging apparatus 10 comprises the display 28, and the CPU 62 outputs the moving image data 80 to the display 28, but the CPU 62 may output the moving image data 80 to a display (not shown) provided outside the imaging apparatus 10.

Further, the CPU 62 performs processing of reflecting the content of the adjustment instruction received by the reception device 76 in the image 200 and the histogram 208, but may perform processing of deriving the adjustment instruction based on the image data 81 and the distance information data 82 and processing of reflecting the derived content of the adjustment instruction in the image 200 and the histogram 208.

In addition, the CPU 62 outputs the histogram data 85 indicating the histogram 208 corresponding to each region 206, but may output the histogram data 85 indicating only the histogram 208 corresponding to any region 206 among the plurality of regions 206.

Further, in a case where no change instruction is received by the reception device 76, the CPU 62 outputs the moving image data 80 including the distance map image data 90 and the reference distance image data 91, but the moving image data 80 may be data including only one of the distance map image data 90 or the reference distance image data 91.

Further, the CPU 62 outputs the moving image data 80 including the region classification image data 92 in the reference distance change processing, but the moving image data 80 may not include the region classification image data 92. Further, in this case, the distance map image 214 and the reference distance image 216 may be displayed on the display 28 based on the distance map image data 90 and the reference distance image data 91 included in the moving image data 80.

Further, the CPU 62 may output the moving image data 80 including the image data 81 in the reference distance change processing. Further, in this case, the image 200, the distance map image 214, and the reference distance image 216 may be displayed on the display 28 based on the image data 81, the distance map image data 90, and the reference distance image data 91 included in the moving image data 80.

In addition, the CPU 62 may output the moving image data 80 including the image data 81 and the region classification image data 92 in the reference distance change processing. Further, in this case, the image 200, the region classification image 222, the distance map image 214, and the reference distance image 216 may be displayed on the display 28 based on the image data 81, the region classification image data 92, the distance map image data 90, and the reference distance image data 91 included in the moving image data 80.

Moreover, the region classification image 222 may be incorporated into a part of the image 200 or may be superimposed on the image 200 using a PinP function. Further, the region classification image 222 may be superimposed on the image 200 using alpha blending. Furthermore, the region classification image 222 may be switched with the image 200.

Further, although the distance information data is acquired by the phase difference type photoelectric conversion element 72 in the above-described embodiment, the technology of the present disclosure is not limited to the phase difference type, the distance information data may be acquired by using a TOF type photoelectric conversion element, or the distance information data may be acquired by using a stereo camera or a depth sensor. Examples of a method of acquiring the distance information data using the TOF type photoelectric conversion element include a method using LiDAR. The distance information data may be acquired in accordance with the frame rate of the image sensor 20 or may be acquired at a time interval longer or shorter than a time interval defined by the frame rate of the image sensor 20.

Further, the CPU 62 performs processing of reflecting the content of the adjustment instruction received by the reception device 76 in the region 206 and the histogram 208 corresponding to the adjustment instruction and of prohibiting the content of the adjustment instruction from being reflected in the region 206 other than the region 206 corresponding to the adjustment instruction and in the histogram 208 other than the histogram 208 corresponding to the adjustment instruction. However, the CPU 62 may perform processing of reflecting the content of the adjustment instruction received by the reception device 76 in the region 206 other than the region 206 corresponding to the adjustment instruction and in the histogram 208 other than the histogram 208 corresponding to the adjustment instruction. In this case, the aspect of the region 206 other than the region 206 corresponding to the adjustment instruction and the aspect of the histogram 208 other than the histogram 208 corresponding to the adjustment instruction can also be changed based on the adjustment instruction received by the reception device 76.

The region 206 other than the region 206 corresponding to the adjustment instruction is an example of a “third region” according to the technology of the present disclosure. The histogram 208 other than the histogram 208 corresponding to the adjustment instruction is an example of “third brightness information” according to the technology of the present disclosure. The histogram data 85 indicating the histogram 208 other than the histogram 208 corresponding to the adjustment instruction is an example of “third brightness information data” according to the technology of the present disclosure. The processing of reflecting the content of the adjustment instruction received by the reception device 76 in the region 206 other than the region 206 corresponding to the adjustment instruction and in the histogram 208 other than the histogram 208 corresponding to the adjustment instruction is an example of “third processing” according to the technology of the present disclosure.

In addition, in a case where the CPU 62 performs the processing of reflecting the content of the adjustment instruction received by the reception device 76 in the region 206 other than the region 206 corresponding to the adjustment instruction and in the histogram 208 other than the histogram 208 corresponding to the adjustment instruction, the CPU 62 may set the processing intensity corresponding to the plurality of distance ranges 212 as follows.

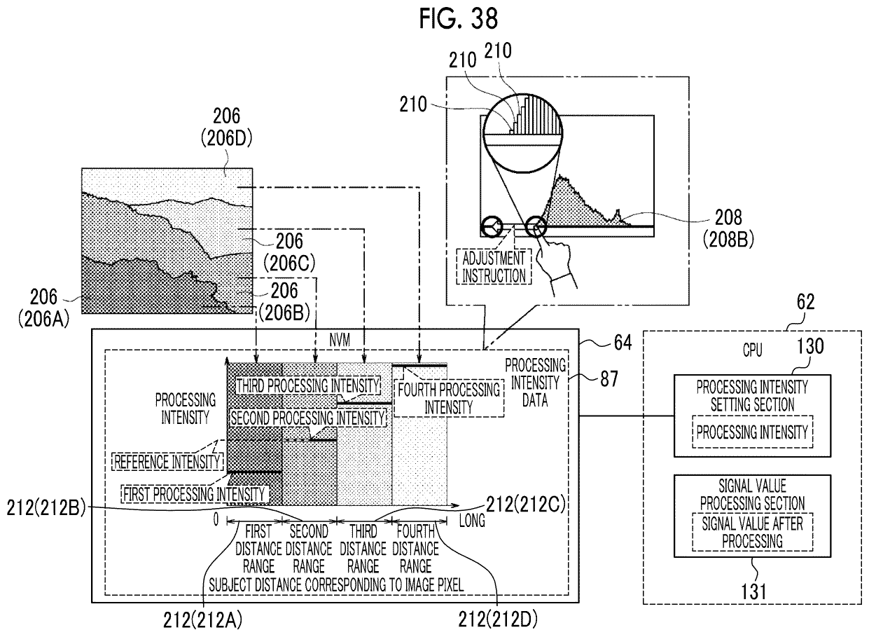

As an example, FIG. 38 shows a first modification example of the processing intensity corresponding to the plurality of distance ranges 212. As an example, the processing intensity data 87 shown in FIG. 38 indicates data in a case where the form of the second histogram 208B is changed based on the adjustment instruction. In the processing intensity data 87 shown in FIG. 38 as an example, the processing intensity corresponding to the plurality of distance ranges 212 varies depending on the subject distance.

In the processing intensity data 87 shown in FIG. 38 as an example, the second processing intensity is set to a constant value corresponding to the reference intensity. That is, for each image pixel corresponding to the second distance range 212B, the change amount of the signal value changed based on the adjustment instruction is constant. In addition, in the example shown in FIG. 38, the first processing intensity, the third processing intensity, and the fourth processing intensity are set to a constant value of zero or more. That is, for each image pixel corresponding to the first distance range 212A, the change amount of the signal value changed based on the adjustment instruction is constant. Similarly, for each image pixel corresponding to the third distance range 212C, the change amount of the signal value changed based on the adjustment instruction is constant, and for each image pixel corresponding to the fourth distance range 212D, the change amount of the signal value changed based on the adjustment instruction is constant.

In addition, the processing intensity varies in the plurality of distance ranges 212. Specifically, the first processing intensity is set to be lower than the second processing intensity. The third processing intensity is set to be higher than the second processing intensity. The fourth processing intensity is set to be higher than the third processing intensity. That is, the processing intensity corresponding to the plurality of distance ranges 212 is set to increase as the value of the subject distance of each distance range 212 increases.

Then, the processing intensity setting section 130 may set the processing intensity corresponding to the plurality of distance ranges 212 based on the processing intensity data 87. Further, the signal value processing section 131 may calculate the signal value after processing for each image pixel based on the processing intensity set by the processing intensity setting section 130.

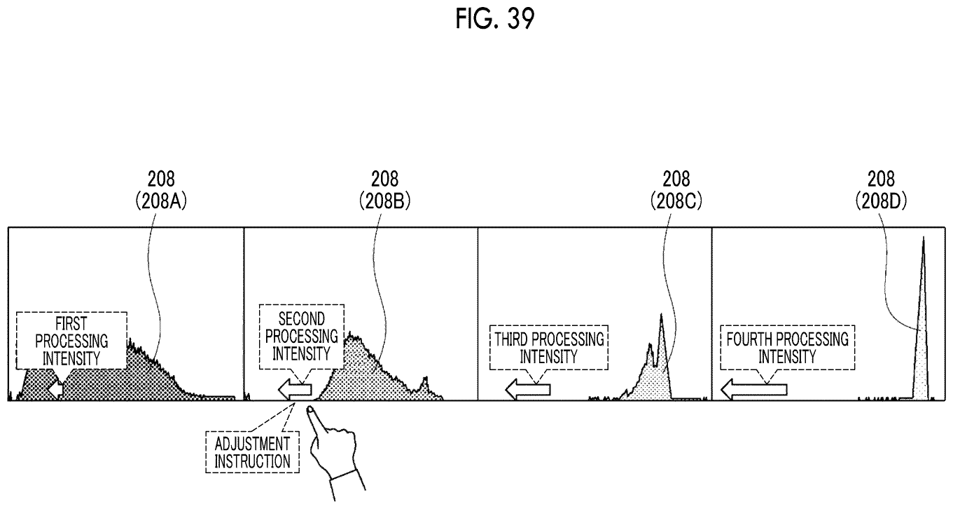

In the example shown in FIG. 38, the signal value corresponding to each distance range 212 can be changed according to the content of the adjustment instruction. As a result, as shown in FIG. 39 as an example, in a case where the adjustment instruction for changing the form of the second histogram 208B is received by the reception device 76, the form of the first histogram 208A can be changed based on the first processing intensity. Similarly, the form of the third histogram 208C can be changed based on the third processing intensity, and the form of the fourth histogram 208D can be changed in accordance with the fourth processing intensity.

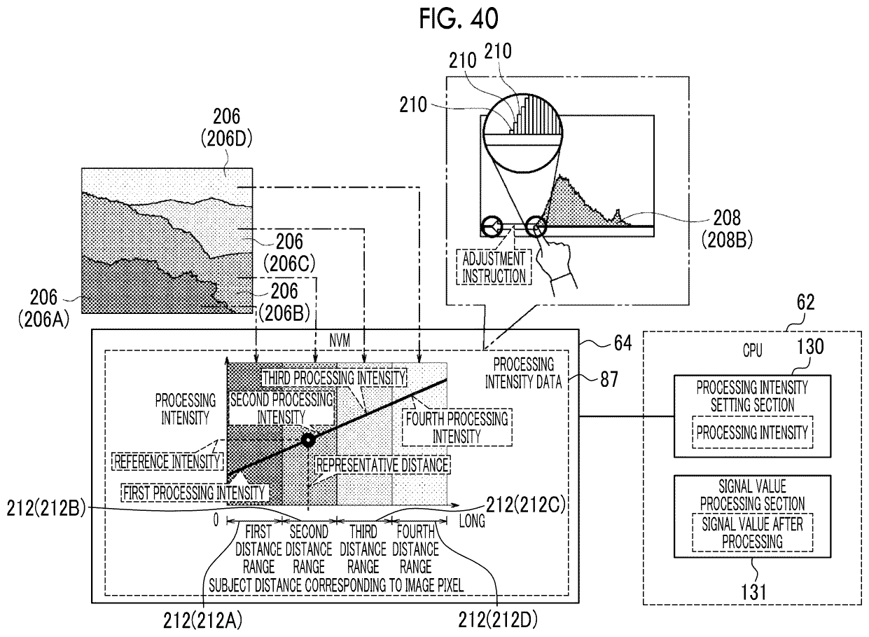

As an example, FIG. 40 shows a second modification example of the processing intensity corresponding to the plurality of distance ranges 212. The processing intensity data 87 shown in FIG. 40 as an example indicates data in a case where the form of the second histogram 208B is changed based on the adjustment instruction. In the processing intensity data 87 shown in FIG. 40 as an example, the processing intensity corresponding to the plurality of distance ranges 212 varies depending on the subject distance. Specifically, the processing intensity corresponding to the plurality of distance ranges 212 is set to be higher as the subject distance becomes longer.

The reference intensity is set based on a representative distance. The representative distance may be an average value of the distance range 212 corresponding to the adjustment instruction, an average value of the subject distances in the distance range 212 corresponding to the adjustment instruction, or a median value of the subject distances in the distance range 212 corresponding to the adjustment instruction.

Then, the processing intensity setting section 130 may set the processing intensity corresponding to the plurality of distance ranges 212 based on the processing intensity data 87. Further, the signal value processing section 131 may calculate the signal value after processing for each image pixel based on the processing intensity set by the processing intensity setting section 130.

In the example shown in FIG. 40 as well, the signal value corresponding to each distance range 212 can be changed according to the content of the adjustment instruction. As a result, as shown in FIG. 39 as an example, in a case where the adjustment instruction for changing the form of the second histogram 208B is received by the reception device 76, the form of the first histogram 208A can be changed based on the first processing intensity. Similarly, the form of the third histogram 208C can be changed based on the third processing intensity, and the form of the fourth histogram 208D can be changed in accordance with the fourth processing intensity.

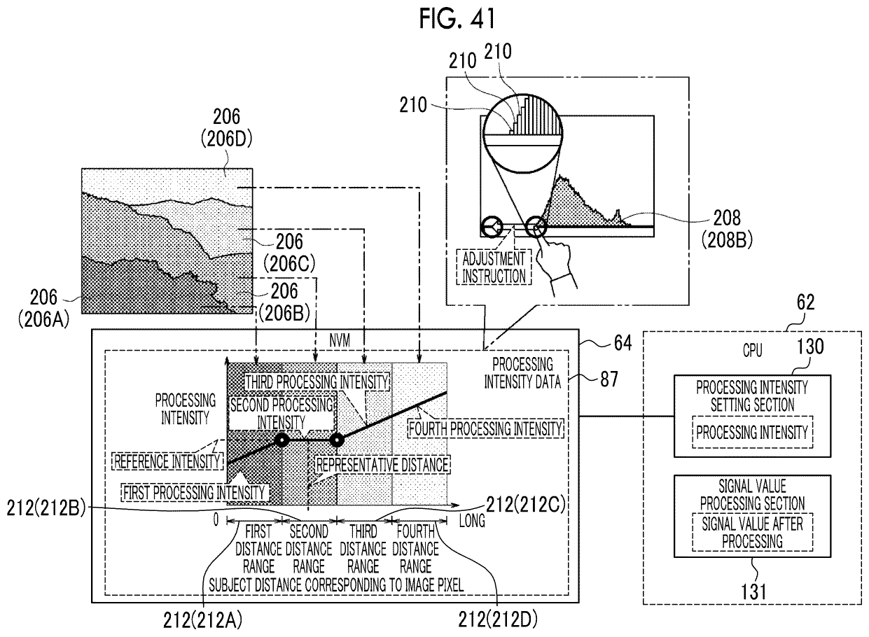

As an example, FIG. 41 shows a third modification example of the processing intensity corresponding to the plurality of distance ranges 212. The processing intensity data 87 shown in FIG. 41 as an example indicates data in a case where the form of the second histogram 208B is changed based on the adjustment instruction. In the processing intensity data 87 shown in FIG. 41 as an example, the processing intensity corresponding to the plurality of distance ranges 212 varies depending on the subject distance.

In the processing intensity data 87 shown in FIG. 41 as an example, the second processing intensity is set to a constant value corresponding to the reference intensity. That is, for each image pixel corresponding to the second distance range 212B, the change amount of the signal value changed based on the adjustment instruction is constant. Further, in the example shown in FIG. 41, the first processing intensity, the third processing intensity, and the fourth processing intensity vary depending on the subject distance. Specifically, the first processing intensity, the third processing intensity, and the fourth processing intensity are set to be higher as the subject distance becomes longer.

Then, the processing intensity setting section 130 may set the processing intensity corresponding to the plurality of distance ranges 212 based on the processing intensity data 87. Further, the signal value processing section 131 may calculate the signal value after processing for each image pixel based on the processing intensity set by the processing intensity setting section 130.

In the example shown in FIG. 41 as well, the signal value corresponding to each distance range 212 can be changed according to the content of the adjustment instruction. As a result, as shown in FIG. 39 as an example, in a case where the adjustment instruction for changing the form of the second histogram 208B is received by the reception device 76, the form of the first histogram 208A can be changed based on the first processing intensity. Similarly, the form of the third histogram 208C can be changed based on the third processing intensity, and the form of the fourth histogram 208D can be changed in accordance with the fourth processing intensity.

In the examples shown in FIGS. 38 to 41, a signal corresponding to the second distance range 212B is an example of a “first signal” according to the technology of the present disclosure. The signals corresponding to the first distance range 212A, the third distance range 212C, and the fourth distance range 212D are examples of a “third signal” according to the technology of the present disclosure. The signal value corresponding to the second distance range 212B is an example of a “first signal value included in the first signal” according to the technology of the present disclosure. The signal values corresponding to the first distance range 212A, the third distance range 212C, and the fourth distance range 212D are examples of a “second signal value included in the third signal” according to the technology of the present disclosure.

In addition, in the examples shown in FIGS. 38 to 41, the plurality of photosensitive pixels 72B corresponding to the second distance range 212B are examples of a “first pixel” according to the technology of the present disclosure. The plurality of photosensitive pixels 72B corresponding to the first distance range 212A, the third distance range 212C, and the fourth distance range 212D are examples of a “second pixel” according to the technology of the present disclosure. The second distance range 212B is an example of a “first distance range” according to the technology of the present disclosure. The first distance range 212A, the third distance range 212C, and the fourth distance range 212D are examples of a “second distance range” according to the technology of the present disclosure. The second region 206B corresponding to the second distance range 212B is an example of a “first region” according to the technology of the present disclosure. The first region 206A corresponding to the first distance range 212A, the third region 206C corresponding to the third distance range 212C, and the fourth region 206D corresponding to the fourth distance range 212D are examples of a “third region” according to the technology of the present disclosure.

The processing intensity may be set to be the same over the entirety of the plurality of distance ranges 212.

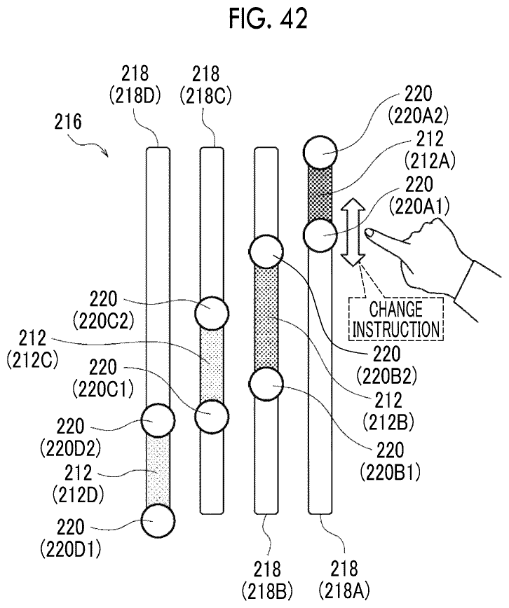

As an example, FIG. 42 shows a modification example of the reference distance image 216. The reference distance image 216 may represent a plurality of scale bars 218 separately indicating the plurality of distance ranges 212. In addition, each of the scale bars 218 is provided with two sliders 220.

Hereinafter, in a case where it is necessary to distinguish between the plurality of scale bars 218 for description, the plurality of scale bars 218 are referred to as a first scale bar 218A, a second scale bar 218B, a third scale bar 218C, and a fourth scale bar 218D. In addition, in a case where it is necessary to distinguish between the plurality of sliders 220 for description, the plurality of sliders 220 are referred to as a first upper limit slider 220A1, a first lower limit slider 220A2, a second upper limit slider 220B1, a second lower limit slider 220B2, a third upper limit slider 220C1, a third lower limit slider 220C2, a fourth upper limit slider 220D1, and a fourth lower limit slider 220D2.

The first scale bar 218A indicates the first distance range 212A. The second scale bar 218B indicates the second distance range 212B. The third scale bar 218C indicates the third distance range 212C. The fourth scale bar 218D indicates the fourth distance range 212D.

The first upper limit slider 220A1 is provided on the first scale bar 218A and indicates a reference distance that defines the upper limit of the first distance range 212A. The first lower limit slider 220A2 is provided on the first scale bar 218A and indicates a reference distance that defines the lower limit of the first distance range 212A. The second upper limit slider 220B1 is provided on the second scale bar 218B and indicates a reference distance that defines the upper limit of the second distance range 212B. The second lower limit slider 220B2 is provided on the second scale bar 218B and indicates a reference distance that defines the lower limit of the second distance range 212B. The third upper limit slider 220C1 is provided on the third scale bar 218C and indicates a reference distance that defines the upper limit of the third distance range 212C. The third lower limit slider 220C2 is provided on the third scale bar 218C and indicates a reference distance that defines the lower limit of the third distance range 212C. The fourth upper limit slider 220D1 is provided on the fourth scale bar 218D and indicates a reference distance that defines the upper limit of the fourth distance range 212D. The fourth lower limit slider 220D2 is provided on the fourth scale bar 218D and indicates a reference distance that defines the lower limit of the fourth distance range 212D.

In the example shown in FIG. 42, the plurality of distance ranges 212 can be independently set. In a case where parts of the adjacent distance ranges 212 overlap each other, parts of the regions 206 corresponding to the adjacent distance ranges 212 are displayed in a mixed aspect in the region classification image 222 (see FIG. 33).

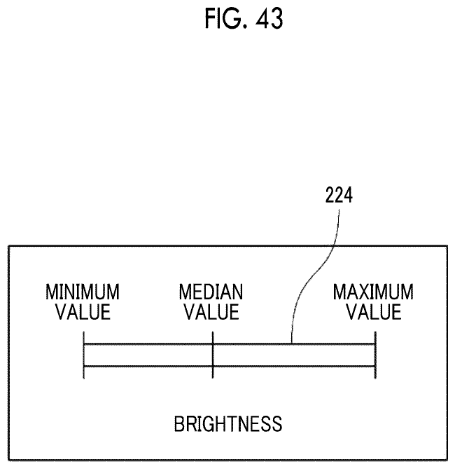

Further, in the above-described embodiment, the histogram 208 is displayed on the display 28 (hereinabove, see FIG. 17) as the brightness information indicating the brightness of each region 206, but as shown in FIG. 43 as an example, a bar 224 visually indicating the maximum value, the minimum value, and the median value of the brightness of each region 206 as statistical numerical values may be displayed on the display 28. The brightness information indicating the brightness of each region 206 may be indicated in a form other than the histogram 208 and the bar 224.

In addition, the above-described embodiments and modification examples can be combined with each other as long as no contradiction occurs. Further, in a case where the above-described embodiments and modification examples are combined, in a case where there are a plurality of overlapping steps, priorities may be given to the plurality of steps according to various conditions or the like.

Further, in each of the above-described embodiments, the CPU 62 has been exemplified, but instead of the CPU 62 or together with the CPU 62, at least one other CPU, at least one GPU, and/or at least one TPU may be used.

In addition, in each of the above-described embodiments, an example of a form in which the program 65 is stored in the NVM 64 has been described, but the technology of the present disclosure is not limited thereto. For example, the program 65 may be stored in a portable non-transitory computer-readable storage medium such as an SSD or a USB memory (hereinafter, simply referred to as a “non-transitory storage medium”). The program 65 stored in the non-transitory storage medium is installed in the controller 12 of the imaging apparatus 10. The CPU 62 executes processing in accordance with the program 65.

Moreover, the program 65 may be stored in a storage device of another computer, a server device, or the like connected to the imaging apparatus 10 via a network, and the program 65 may be downloaded in response to the request of the imaging apparatus 10 and installed in the controller 12.

It is not necessary to store the entire program 65 in the storage device of the other computer, the server device, or the like connected to the imaging apparatus 10 or in the NVM 64, and a part of the program 65 may be stored.

Further, although the controller 12 is built into the imaging apparatus 10, the technology of the present disclosure is not limited thereto, and for example, the controller 12 may be provided outside the imaging apparatus 10.

Further, in each of the above-described embodiments, although the controller 12 including the CPU 62, the NVM 64, and the RAM 66 has been exemplified, the technology of the present disclosure is not limited thereto, and a device including an ASIC, an FPGA, and/or a PLD may be applied instead of the controller 12. Alternatively, a combination of a hardware configuration and a software configuration may be used instead of the controller 12.

Further, the following various processors can be used as a hardware resource for executing the moving image generation processing described in each of the above-described embodiments. Examples of the processors include a CPU that is a general-purpose processor functioning as the hardware resource for executing the moving image generation processing by executing software, that is, a program. Further, examples of the processors include a dedicated electrical circuit that is a processor having a circuit configuration dedicatedly designed to execute a specific type of processing such as an FPGA, a PLD, or an ASIC. A memory is built into or connected to any processor, and any processor executes the moving image generation processing by using the memory.

The hardware resource for executing the moving image generation processing may be configured with one of these various processors or may be configured with a combination of two or more processors of the same type or different types (for example, a combination of a plurality of FPGAs or a combination of a CPU and an FPGA). In addition, the hardware resource for executing the moving image generation processing may be one processor.

As an example in which the hardware resource is configured with one processor, first, there is a form in which one processor is configured with a combination of one or more CPUs and software, and this processor functions as the hardware resource for executing the moving image generation processing. Secondly, as represented by SoC or the like, there is a form in which a processor that implements the function of the entire system including a plurality of hardware resources for executing the moving image generation processing with one IC chip is used. As described above, the moving image generation processing is implemented using one or more of the above-described various processors as the hardware resource.

Furthermore, as a hardware structure of these various processors, more specifically, an electrical circuit in which circuit elements such as semiconductor elements are combined can be used. Additionally, the above-described moving image generation processing is merely an example. Therefore, needless to say, unnecessary steps may be deleted, new steps may be added, or the processing order may be changed within the scope that does not depart from the gist.

The contents described and shown above are detailed descriptions for portions according to the technology of the present disclosure and are merely an example of the technology of the present disclosure. For example, the above description regarding the configuration, function, operation, and effect is a description regarding an example of the configuration, function, operation, and effect of the portions according to the technology of the present disclosure. Accordingly, needless to say, unnecessary portions may be deleted, new elements may be added, or replacement may be made with respect to the contents described and shown above within the scope that does not depart from the gist of the technology of the present disclosure. In addition, in order to avoid complication and facilitate understanding of portions according to the technology of the present disclosure, description regarding common technical knowledge or the like that does not need to be particularly described in order to enable implementation of the technology of the present disclosure is omitted in the contents described and shown above.

In the present specification, “A and/or B” is synonymous with “at least one of A or B”. In other words, “A and/or B” means that only A may be used, only B may be used, or a combination of A and B may be used. In addition, in the present specification, in a case where three or more matters are expressed by “and/or” in combination, the same concept as “A and/or B” is applied.

All documents, patent applications, and technical standards described in this specification are herein incorporated by reference to the same extent as in a case where each individual document, patent application, or technical standard was specifically and individually indicated to be incorporated by reference.

With regard to the above-described embodiment, the following appendix is further disclosed.

### Appendix 1

An image processing apparatus comprising:
a processor,
in which the processor is configured to:
   acquire distance information data related to distance information between an image sensor and a subject;
   output first image data indicating a first image obtained by imaging with the image sensor;
   output first brightness information data indicating first brightness information created based on a signal of the first image data for at least a first region among a plurality of regions into which the first image is classified according to the distance information; and
   perform first processing of reflecting a content of the first instruction derived based on the first image data and the distance information data in the first image and/or the first brightness information.

What is claimed is:

1. An image processing apparatus comprising:
a processor,
wherein the processor is configured to:
acquire distance information data related to distance information between an image sensor and a subject;
output first image data indicating a first image obtained by imaging with the image sensor;
output first brightness information data indicating first brightness information created based on a first signal of the first image data, for each of a plurality of regions into which the first image is classified according to the distance information; and
in a case in which a first instruction to adjust the first brightness information for at least one of the plurality of regions is received by a reception device, perform first processing of reflecting a content of the first instruction in the first image and/or the first brightness information.

2. The image processing apparatus according to claim 1,
wherein the first brightness information is a first histogram.

3. The image processing apparatus according to claim 2,
wherein the first histogram indicates a relationship between a signal value and the number of pixels.

4. The image processing apparatus according to claim 1,
wherein the processor is configured to output second brightness information data indicating second brightness information created based on a second signal of the first image data for a second region among the plurality of regions, and
the first processing includes second processing of prohibiting the content of the first instruction from being reflected in the second region and/or the second brightness information.

5. The image processing apparatus according to claim 1,
wherein the processor is configured to output third brightness information data indicating third brightness information created based on a third signal of the first image data for a third region among the plurality of regions, and
the first processing includes third processing of reflecting the content of the first instruction in the third region and/or the third brightness information.

6. The image processing apparatus according to claim 5,
wherein the first processing is processing of changing the first signal according to the content of the first instruction,
the third processing is processing of changing the third signal according to the content of the first instruction, and
a change amount of a first signal value included in the first signal is different from a change amount of a second signal value included in the third signal.

7. The image processing apparatus according to claim 6,
wherein, in a case where a range of distances between a plurality of first pixels corresponding to the first region and the subject is set as a first distance range, and a range of distances between a plurality of second pixels corresponding to the third region and the subject is set as a second distance range,
the change amount of the first signal value is constant in the first distance range, and
the change amount of the second signal value is constant in the second distance range.

8. The image processing apparatus according to claim 5,
wherein the first processing is processing of changing the first signal according to the content of the first instruction,
the third processing is processing of changing the third signal according to the content of the first instruction, and
a change amount of a second signal value included in the third signal varies depending on distances between a plurality of second pixels corresponding to the third region and the subject.

9. The image processing apparatus according to claim 1,
wherein the first processing is processing of changing the first signal according to the content of the first instruction.

10. The image processing apparatus according to claim 1,
wherein the first instruction is an instruction to change a form of the first brightness information.

11. The image processing apparatus according to claim 1,
wherein the first brightness information is a second histogram having a plurality of bins, and
the first instruction is an instruction to move a bin corresponding to a third signal value selected based on the first instruction among the plurality of bins.

12. The image processing apparatus according to claim 1,
wherein the processor is configured to output second image data indicating a second image in which the plurality of regions are divided in different aspects according to the distance information.

13. The image processing apparatus according to claim 1,
wherein the processor is configured to:
output third image data indicating a distance map image representing a distribution of the distance information with respect to an angle of view of a first imaging apparatus equipped with the image sensor; and
output fourth image data indicating a reference distance image representing a reference distance for classifying the plurality of regions.

14. The image processing apparatus according to claim 13,
wherein the reference distance image is an image showing a scale bar and a slider,
the scale bar indicates a plurality of distance ranges corresponding to the plurality of regions,
the slider is provided on the scale bar, and
a position of the slider indicates the reference distance.

15. The image processing apparatus according to claim 14,
wherein the scale bar is one scale bar collectively indicating the plurality of distance ranges.

16. The image processing apparatus according to claim 14,
wherein the scale bar is a plurality of scale bars separately indicating the plurality of distance ranges.

17. The image processing apparatus according to claim 13,
wherein the processor is configured to, in a case where the reception device receives a second instruction to output the third image data and/or the fourth image data, output fifth image data indicating a third image in which the plurality of regions are divided in different aspects according to the distance information.

18. The image processing apparatus according to claim 13,
wherein the processor is configured to, in a case where the reception device receives a third instruction related to the reference distance, perform fourth processing of reflecting a content of the third instruction in the reference distance image, and change the reference distance according to the content of the third instruction.

19. The image processing apparatus according to claim 1,
wherein the first image data is moving image data.

20. The image processing apparatus according to claim 1,
wherein the image processing apparatus is an imaging apparatus.

21. The image processing apparatus according to claim 1,
wherein the processor is configured to output the first image data and/or the first brightness information data to a display destination.

22. The image processing apparatus according to claim 21,
wherein the first processing is processing of changing a display aspect of the first image and/or the first brightness information displayed on the display destination.

23. The image processing apparatus according to claim 1,
wherein the image sensor has a plurality of phase difference pixels, and
the processor is configured to acquire the distance information data based on phase difference pixel data output from the phase difference pixels.

24. The image processing apparatus according to claim 23,
wherein the phase difference pixel is a pixel for selectively outputting non-phase difference pixel data and the phase difference pixel data,
the non-phase difference pixel data is pixel data obtained by performing photoelectric conversion on an entire region of the phase difference pixel, and
the phase difference pixel data is pixel data obtained by performing photoelectric conversion on a partial region of the phase difference pixel.

25. An image processing method comprising:
acquiring distance information data related to distance information between an image sensor and a subject;
outputting first image data indicating a first image obtained by imaging with the image sensor;
outputting first brightness information data indicating first brightness information created based on a first signal of the first image data, for each of a plurality of regions into which the first image is classified according to the distance information; and
in a case in which a first instruction to adjust the first brightness information for at least one of the plurality of regions is received by a reception device, performing first processing of reflecting a content of the first instruction in the first image and/or the first brightness information.

26. A non-transitory computer-readable storage medium storing a program for causing a computer to execute a process comprising:
acquiring distance information data related to distance information between an image sensor and a subject;
outputting first image data indicating a first image obtained by imaging with the image sensor;
outputting first brightness information data indicating first brightness information created based on a first signal of the first image data, for each of a plurality of regions into which the first image is classified according to the distance information; and
in a case in which a first instruction to adjust the first brightness information for at least one of the plurality of regions is received by a reception device, performing first processing of reflecting a content of the first instruction in the first image and/or the first brightness information.
